(19) United States
(12) Patent Application Publication
(10) Pub. No.: US 2021/0150788 A1
(43) Pub. Date: May 20, 2021

(54) MEDIA VECTORIZATION

(71) Applicant: DOT LEARN INC., Edison, NJ (US)

(72) Inventors: Samrat Bhattacharyya, Edison, NJ (US); Krishna Savant Syreddy, Telangana (IN); Avijit Kundal, Bengaluru (IN)

(21) Appl. No.: 17/018,067

(22) Filed: Sep. 11, 2020

Related U.S. Application Data
(60) Provisional application No. 62/937,587, filed on Nov. 19, 2019.

(51) Int. Cl. G06T 11/60; G06T 7/70; G06T 7/64

(52) U.S. Cl. CPC G06T 11/60; G06T 2207/10016; G06T 7/64; G06T 7/70

(57) ABSTRACT

Examples of the disclosure include a method of converting media content from a first format to a vector-graphics format, the method comprising receiving video media content in the first format, detecting a plurality of scenes in the video media content, selecting at least one scene of the plurality of scenes for conversion to the vector-graphics format, identifying a plurality of objects including a first object in the at least one scene, determining at least one of a morphing of the first object and a transformation of the first object in the at least one scene, converting the plurality of objects from the first format to the vector-graphics format, and storing information indicative of the first object and the at least one of the morphing of the first object and the transformation of the first object in the vector-graphics format.

### CROSS-REFERENCE TO RELATED APPLICATION

This application claims priority under 35 U.S.C. § 119(e) to U.S. Provisional Application Ser. No. 62/937,587, titled “MEDIA VECTORIZATION,” filed on Nov. 19, 2019, which is hereby incorporated by reference in its entirety.

### FIELD OF TECHNOLOGY

At least one example in accordance with the present disclosure relates generally to converting media content into a vector format.

### SUMMARY

According to at least one aspect of the present disclosure, a method of converting media content from a first format to a vector-graphics format is provided, the method comprising receiving video media content in the first format, detecting a plurality of scenes in the video media content, selecting at least one scene of the plurality of scenes for conversion to the vector-graphics format, identifying a plurality of objects including a first object in the at least one scene, converting the plurality of objects to the vector-graphics format, determining at least one of a morphing of the first object and a transformation of the first object in the at least one scene, and storing information indicative of the first object and the at least one of the morphing of the first object and the transformation of the first object in the vector-graphics format.

In various examples, the first format is a raster-graphics format. In some examples, selecting the at least one scene for conversion to the vector-graphics format includes determining a plurality of gradient intensity values corresponding to a plurality of pixels in a frame of the at least one scene, determining a first number of gradient intensity values falling within a first threshold range, determining a second number of gradient intensity values falling within a second threshold range, the second threshold range being different than the first threshold range, and determining that the at least one scene may be converted to the vector-graphics format based on a difference between the first number of gradient intensity values and the second number of gradient intensity values. In some examples, the first object includes a plurality of pixels, and wherein identifying the first object includes assigning a first pixel of the plurality of pixels to a first region, and adding at least one border pixel of the plurality of pixels to the first region responsive to determining that the at least one border pixel has a color value within a threshold range of a color value of the first region, the at least one border pixel being adjacent to the first region.

In at least one example, converting the first object to the vector-graphics format includes identifying a plurality of border pixels of the first object, the plurality of border pixels including a plurality of corner pixels, identifying a least-cost path around the plurality of border pixels via the plurality of corner pixels, generating a simplified object, the simplified object having a border indicated by the least-cost path, and determining one or more curves representing the simplified object to generate a vectorized object, the vectorized object having a border indicated by the one or more curves. In various examples, the method further includes identifying the first object as a foreground object, and identifying a second object as a background object. In some examples, identifying the second object as the background object includes identifying a plurality of images each including a respective portion of the background object, combining the plurality of images to generate a static image of the background object, and storing the static image of the background object.

According to at least one aspect of the disclosure, a non-transitory computer-readable medium storing thereon sequences of computer-executable instructions for converting media content from a first format to a vector-graphics format is provided, the sequences of computer-executable instructions including instructions that instruct at least one processor to receive video media content in the first format, detect a plurality of scenes in the video media content, select at least one scene of the plurality of scenes for conversion to the vector-graphics format, identify a plurality of objects including a first object in the at least one scene, convert the plurality of objects to the vector-graphics format, determine at least one of a morphing of the first object and a transformation of the first object in the at least one scene, and store information indicative of the first object and the at least one of the morphing of the first object and the transformation of the first object in the vector-graphics format.

In various examples, the first format is a raster-graphics format. In some examples, in instructing the at least one processor to select the at least one scene for conversion to the vector-graphics format, the instructions are further configured to instruct the at least one processor to determine a plurality of gradient intensity values corresponding to a plurality of pixels in a frame of the at least one scene, determine a first number of gradient intensity values falling within a first threshold range, determine a second number of gradient intensity values falling within a second threshold range, the second threshold range being different than the first threshold range, and determine that the at least one scene may be converted to the vector-graphics format based on a difference between the first number of gradient intensity values and the second number of gradient intensity values.

In some examples, the first object includes a plurality of pixels, and wherein in instructing the at least one processor to identify the first object, the instructions are further configured to instruct the at least one processor to assign a first pixel of the plurality of pixels to a first region, and add at least one border pixel of the plurality of pixels to the first region responsive to determining that the at least one border pixel has a color value within a threshold range of a color value of the first region, the at least one border pixel being adjacent to the first region. In at least one example, in instructing the at least one processor to convert the first object to the vector-graphics format, the instructions are further configured to instruct the at least one processor to identify a plurality of border pixels of the first object, the plurality of border pixels including a plurality of corner pixels, identify a least-cost path around the plurality of border pixels via the plurality of corner pixels, generate a simplified object, the simplified object having a border indicated by the least-cost path, and determine one or more curves representing the simplified object to generate a vectorized object, the vectorized object having a border indicated by the one or more curves.

In at least one example, the instructions are further configured to instruct the at least one processor to identify the first object as a foreground object, and identify a second object as a background object. In various examples, in instructing the at least one processor to identify the second object as the background object, the instructions are further configured to instruct the at least one processor to identify a plurality of images each including a respective portion of the background object, combine the plurality of images to generate a static image of the background object, and store the static image of the background object.

According to at least one aspect of the disclosure, a computing device configured to convert media content from a first format to a vector-graphics format is provided, the computing device comprising a communication interface, a storage, and a controller configured to receive, via the communication interface, video media content in the first format, detect a plurality of scenes in the video media content, select at least one scene of the plurality of scenes for conversion to the vector-graphics format, identify a plurality of objects including a first object in the at least one scene, convert the plurality of objects to the vector-graphics format, determine at least one of a morphing of the first object and a transformation of the first object in the at least one scene, and store information indicative of the first object and the at least one of the morphing of the first object and the transformation of the first object in the vector-graphics format in the storage.

In various examples, the first format is a raster-graphics format. In some examples, in selecting the at least one scene for conversion to the vector-graphics format, the controller is further configured to determine a plurality of gradient intensity values corresponding to a plurality of pixels in a frame of the at least one scene, determine a first number of gradient intensity values falling within a first threshold range, determine a second number of gradient intensity values falling within a second threshold range, the second threshold range being different than the first threshold range, and determine that the at least one scene may be converted to the vector-graphics format based on a difference between the first number of gradient intensity values and the second number of gradient intensity values.

In some examples, the first object includes a plurality of pixels, and wherein in identifying the first object, the controller is further configured to assign a first pixel of the plurality of pixels to a first region, and add at least one border pixel of the plurality of pixels to the first region responsive to determining that the at least one border pixel has a color value within a threshold range of a color value of the first region, the at least one border pixel being adjacent to the first region.

In at least one example, in converting the first object to the vector-graphics format, the controller is further configured to identify a plurality of border pixels of the first object, the plurality of border pixels including a plurality of corner pixels, identify a least-cost path around the plurality of border pixels via the plurality of corner pixels, generate a simplified object, the simplified object having a border indicated by the least-cost path, and determine one or more curves representing the simplified object to generate a vectorized object, the vectorized object having a border indicated by the one or more curves. In various examples, the controller is further configured to identify the first object as a foreground object, identify a second object as a background object, identify a plurality of images each including a respective portion of the background object, combine the plurality of images to generate a static image of the background object, and store the static image of the background object in the storage.

According to at least one aspect, a method of converting media content from a first format to a vector-graphics format is provided, the method comprising receiving video media content in the first format, detecting a plurality of scenes in the video media content, selecting at least one scene of the plurality of scenes for conversion to the vector-graphics format, identifying a plurality of objects including a first object in the at least one scene, determining at least one of a morphing of the first object and a transformation of the first object in the at least one scene, converting the plurality of objects from the first format to the vector-graphics format, and storing information indicative of the first object and the at least one of the morphing of the first object and the transformation of the first object in the vector-graphics format.

In some examples, the first format is a raster-graphics format. In at least one example, selecting the at least one scene for conversion to the vector-graphics format includes determining a plurality of gradient intensity values corresponding to a plurality of pixels in a frame of the at least one scene, determining a first number of gradient intensity values falling within a first threshold range, determining a second number of gradient intensity values falling within a second threshold range, the second threshold range being different than the first threshold range, and determining that the at least one scene may be converted to the vector-graphics format based on a difference between the first number of gradient intensity values and the second number of gradient intensity values.

In various examples, the at least one scene includes a first frame and a second frame, the second frame being subsequent to the first frame, the first frame including a first plurality of pixels representing the first object and the second frame including a second plurality of pixels representing the first object, and wherein identifying the first object includes assigning a first pixel of the first plurality of pixels to a first region, adding at least one first border pixel of the first plurality of pixels to the first region responsive to determining that the at least one first border pixel has a color value within a threshold range of a color value of the first region, the at least one first border pixel being adjacent to the first region, and adding at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

In at least one example, converting the first object to the vector-graphics format includes determining a contour of the first object, determining a plurality of key points along the contour, and determining one or more segments between key points of the plurality of key points, the one or more segments being represented in a vector-graphics format. In various examples, the method includes identifying the first object as a foreground object, and identifying a second object as a background object. In some examples, identifying the second object as the background object includes identifying a plurality of images each including a respective portion of the background object, combining the plurality of images to generate a static image of the background object, and storing the static image of the background object.

According to at least one aspect, a non-transitory computer-readable medium storing thereon sequences of computer-executable instructions for converting media content from a first format to a vector-graphics format is provided, the sequences of computer-executable instructions including instructions that instruct at least one processor to receive video media content in the first format, detect a plurality of scenes in the video media content, select at least one scene of the plurality of scenes for conversion to the vector-graphics format, identify a plurality of objects including a first object in the at least one scene, determine at least one of a morphing of the first object and a transformation of the first object in the at least one scene, convert the plurality of objects from the first format to the vector-graphics format, and store information indicative of the first object and the at least one of the morphing of the first object and the transformation of the first object in the vector-graphics format.

In various examples, the first format is a raster-graphics format. In some examples, in instructing the at least one processor to select the at least one scene for conversion to the vector-graphics format, the instructions are further configured to instruct the at least one processor to determine a plurality of gradient intensity values corresponding to a plurality of pixels in a frame of the at least one scene, determine a first number of gradient intensity values falling within a first threshold range, determine a second number of gradient intensity values falling within a second threshold range, the second threshold range being different than the first threshold range, and determine that the at least one scene may be converted to the vector-graphics format based on a difference between the first number of gradient intensity values and the second number of gradient intensity values.

In at least one example, the at least one scene includes a first frame and a second frame, the second frame being subsequent to the first frame, the first frame including a first plurality of pixels representing the first object and the second frame including a second plurality of pixels representing the first object, and wherein in instructing the at least one processor to identify the first object, the instructions are further configured to instruct the at least one processor to assign a first pixel of the first plurality of pixels to a first region, add at least one first border pixel of the first plurality of pixels to the first region responsive to determining that the at least one first border pixel has a color value within a threshold range of a color value of the first region, the at least one first border pixel being adjacent to the first region, and add at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

In some examples, in instructing the at least one processor to convert the first object to the vector-graphics format, the instructions are further configured to instruct the at least one processor to determine a contour of the first object, determine a plurality of key points along the contour, and determine one or more segments between key points of the plurality of key points, the one or more segments being represented in a vector-graphics format. In at least one example, the instructions are further configured to instruct the at least one processor to identify the first object as a foreground object, and identify a second object as a background object. In various examples, in instructing the at least one processor to identify the second object as the background object, the instructions are further configured to instruct the at least one processor to identify a plurality of images each including a respective portion of the background object, combine the plurality of images to generate a static image of the background object, and store the static image of the background object.

According to some aspects, a computing device configured to convert media content from a first format to a vector-graphics format is provided, the computing device comprising a communication interface, a storage, and a controller configured to receive, via the communication interface, video media content in the first format, detect a plurality of scenes in the video media content, select at least one scene of the plurality of scenes for conversion to the vector-graphics format, identify a plurality of objects including a first object in the at least one scene, determine at least one of a morphing of the first object and a transformation of the first object in the at least one scene, convert the plurality of objects from the first format to the vector-graphics format, and store information indicative of the first object and the at least one of the morphing of the first object and the transformation of the first object in the vector-graphics format in the storage.

In some examples, the first format is a raster-graphics format. In at least one example, in selecting the at least one scene for conversion to the vector-graphics format, the controller is further configured to determine a plurality of gradient intensity values corresponding to a plurality of pixels in a frame of the at least one scene, determine a first number of gradient intensity values falling within a first threshold range, determine a second number of gradient intensity values falling within a second threshold range, the second threshold range being different than the first threshold range, and determine that the at least one scene may be converted to the vector-graphics format based on a difference between the first number of gradient intensity values and the second number of gradient intensity values.

In various examples, the at least one scene includes a first frame and a second frame, the second frame being subsequent to the first frame, the first frame including a first plurality of pixels representing the first object and the second frame including a second plurality of pixels representing the first object, the controller is further configured to assign a first pixel of the first plurality of pixels to a first region, add at least one first border pixel of the first plurality of pixels to the first region responsive to determining that the at least one first border pixel has a color value within a threshold range of a color value of the first region, the at least one first border pixel being adjacent to the first region, and add at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

In some examples, in converting the first object to the vector-graphics format, the controller is further configured to determine a contour of the first object, determine a plurality of key points along the contour, and determine one or more segments between key points of the plurality of key points, the one or more segments being represented in a vector-graphics format. In various examples, the controller is further configured to identify the first object as a foreground object, identify a second object as a background object, identify a plurality of images each including a respective portion of the background object, combine the plurality of images to generate a static image of the background object, and store the static image of the background object in the storage.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a communication system according to an example;

FIG. 2 illustrates a process of converting at least a portion of media content from a first format to a second format according to an example;

FIG. 3 illustrates a process of determining whether a scene is vectorizable according to an example;

FIG. 4A illustrates a first image of a first frame which may be extracted from a first scene according to an example;

FIG. 4B illustrates a first plurality of binary images generated based on the first image of the first frame according to an example;

FIG. 5A illustrates a second image of a second frame which may be extracted from a second scene according to an example;

FIG. 5B illustrates a second plurality of binary images generated based on the second image of the second frame according to an example;

FIG. 6A illustrates a first graph indicating an edge pixel count for the first plurality of binary images against a selected gradient standard deviation value according to an example;

FIG. 6B illustrates a second graph indicating an edge pixel count for the second plurality of binary images against a selected gradient standard deviation value according to an example;

FIG. 7 illustrates a process of segmenting objects in a frame according to an example;

FIG. 8 illustrates a first schematic view of an object represented in a raster-graphics format according to an example;

FIG. 9 illustrates a process of tracing objects for vectorization according to an example;

FIG. 10 illustrates a second schematic view of the object represented in the raster-graphics format according to an example;

FIG. 11 illustrates a schematic view of a simplified object based on the object represented in the raster-graphics format according to an example;

FIG. 12 illustrates a schematic view of a modified object based on the simplified object according to an example;

FIG. 13 illustrates a process of identifying border pixels according to an example;

FIG. 14 illustrates a process of simplifying an object according to an example;

FIG. 15A illustrates a block diagram of a view in a scene at a first time according to an example;

FIG. 15B illustrates a block diagram of the view in the scene at a second time according to an example;

FIG. 16 illustrates a process of identifying background objects according to an example;

FIG. 17 illustrates a block diagram of features of a storage format according to an example;

FIG. 18 illustrates a process of converting media content including presentation slides to a vector-graphics format according to an example;

FIG. 19 illustrates a process of converting at least a portion of media content from a first format to a second format according to an example;

FIG. 20A illustrates a front view of a first frame of a scene according to an example;

FIG. 20B illustrates a front view of a second frame of the scene according to an example;

FIG. 21 illustrates a perspective view of the first frame and the second frame in a three-dimensional matrix according to an example;

FIG. 22 illustrates a process of segmenting and tracking objects in a scene according to an example;

FIG. 23 illustrates a schematic view of a Bézier curve according to an example;

FIG. 24 illustrates another schematic view of a Bézier curve according to an example;

FIG. 25 illustrates a schematic view of a first Bézier curve and a second Bézier curve according to an example;

FIG. 26 illustrates a schematic view of a triangle fan representing a polygon according to an example;

FIG. 27A illustrates a schematic view of a polygon according to an example;

FIG. 27B illustrates a schematic view of the polygon with control points according to an example;

FIG. 27C illustrates a schematic view of a coarse polygon and Bézier curves representing the polygon according to an example;

FIG. 28A illustrates a schematic view of a coarse polygon according to an example;

FIG. 28B illustrates a schematic view of Bézier curve regions according to an example;

FIG. 28C illustrates a schematic view of a modified coarse polygon according to an example;

FIG. 28D illustrates a schematic view of a resultant polygon according to an example;

FIG. 29A illustrates a schematic view of a first polygon and a second polygon;

FIG. 29B illustrates a schematic view of the first polygon and the second polygon represented by individual portions according to an example;

FIG. 29C illustrates a flow diagram of generating a resultant polygon based on a series of operations executed with respect to the individual portions of the first polygon and the second polygon according to an example;

FIG. 30 illustrates a process of converting media content from a first format to a second format according to an example; and

FIG. 31 illustrates a shape represented by a contour according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As worldwide Internet access and usage expands, Internet traffic (including, for example, transmission of image and video media content) continues to rise. Consequently, costs associated with facilitating information exchange via the Internet, such as server costs, continue to rise. Furthermore, information transfer speeds continue to increase in proportion with the size of the transmitted information. Reducing an information size of media content may advantageously result in reduced costs and increased information transfer speeds.

Certain media content may be represented by various formats. For example, videos may be represented by one of several formats including a raster-graphics format and a vector-graphics format. In some examples, the displayed appearance a video represented in a raster-graphics format may be indistinguishable or nearly indistinguishable from the same video represented in a vector-graphics format. However, an information size of the video may vary based on the format of the video. It may therefore be advantageous to represent a video (or portions thereof) in a vector-graphics format in examples in which the information size of the video is less than that of the video in a raster-graphics format, and in which the video in the vector-graphics format is at least nearly visually indistinguishable to a user from the video in the raster-graphics format. Consequently, it may be advantageous to provide a codec capable of converting at least portions of a video from a raster-graphics format to a vector-graphics format where the above criteria are met, such that an information size of the video may be reduced without adversely impacting video quality.

Examples described herein provide systems and methods of converting media content, including videos, from a raster-graphics format to a vector-graphics format. In various examples, a codec is provided which converts input media content into a vector-graphics format, stores the converted media content in an appropriate file format, and decodes the stored media content for playback to a user. Accordingly, examples provided herein enable an information size of various media content to be reduced, thereby reducing costs and information transfer times.

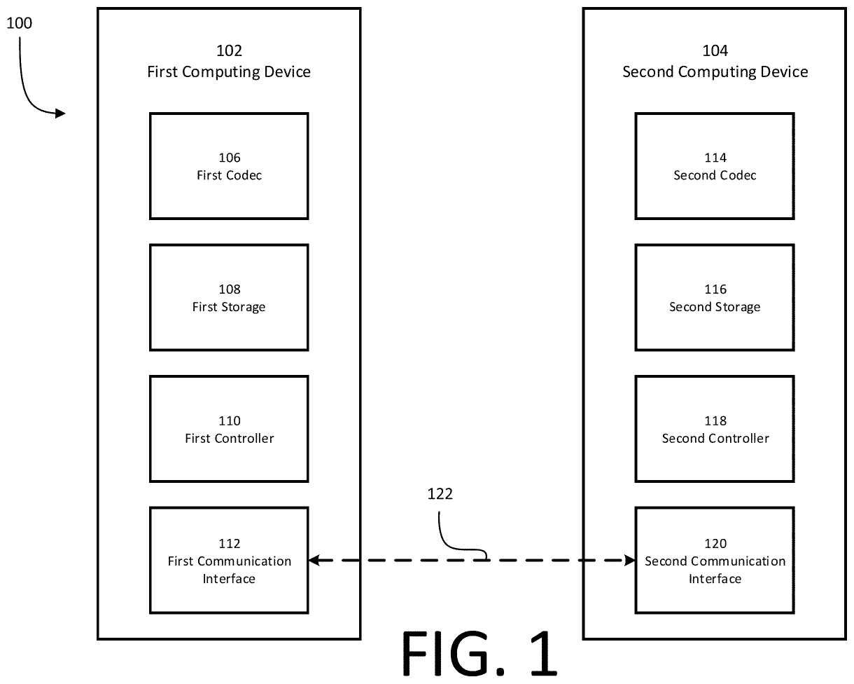

FIG. 1 illustrates a block diagram of a communication system 100 according to an example. The communication system 100 includes a first computing device 102 and a second computing device 104. The first computing device 102 includes a first codec 106, a first storage 108, a first controller 110, and a first communication interface 112. The second computing device 104 includes a second codec 114, a second storage 116, a second controller 118, and a second communication interface 120. The first communication interface 112 is communicatively coupled to the second communication interface 120 via a network connection 122, such as a wired or wireless network connection.

The first codec 106 and the second codec 114 each include an encoder, a storage format, and a decoder. The encoder is configured to convert media content from a first format to a second format, where the second format may be a file format indicated by the storage format. The decoder is configured to convert media content encoded in the file format for playback to a user. For example, and as discussed in greater detail below, the first codec 106 may encode media content into the file format and provide the encoded media content to the second codec 114, which decodes the encoded media content for playback to a user.

The first storage 108 and the second storage 116 are configured to store information. For example, the first storage 108 and the second storage 116 may be configured to store media content encoded by the first codec 106 and/or the second codec 114 and information corresponding to operation of the codecs 106, 114 themselves. The first controller 110 and the second controller 118 are configured to control operation of the first computing device 102 and the second computing device 104, respectively, as discussed in greater detail below. For example, although the controllers 110, 118 are indicated as separate from the codecs 106, 114 for purposes of clarity, in some examples the controllers 110, 118 may execute the codecs 106, 114, respectively, to perform the operations discussed below, such as in examples in which the codecs 106, 114 include a computer program.

The first communication interface 112 and the second communication interface 120 are configured to enable communication with one or more external devices. For example, the first communication interface 112 and the second communication interface 120 may include a wireless interface (for example, an antenna), a wired interface (for example, a wired communication port), or both.

In various examples, the first computing device 102 may be a server, and the second computing device 104 may be a user device. For example, the first computing device 102 may be a server hosting media content, such as video media content that has been uploaded to the first computing device 102. A user of the second computing device 104 may wish to access content hosted by the first computing device 102, such as video media content, for playback.

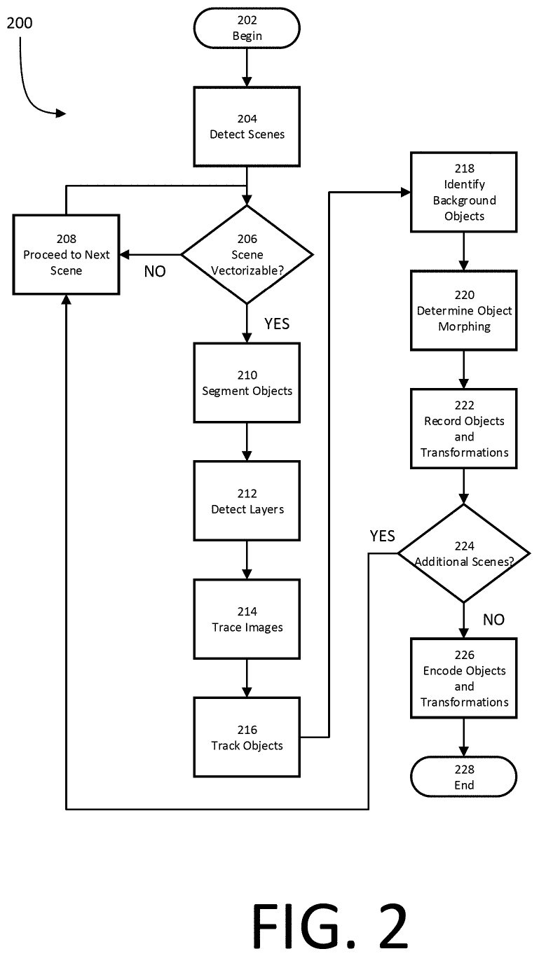

In one example, video media content is uploaded to the first computing device 102 in a raster-graphics format. The video media content may be uploaded from one of several sources, such as a personal computing device of a user (for example, a personal computing device similar to examples of the second computing device 104). As discussed above, and as discussed in greater detail below with respect to FIG. 2, the first codec 106 may convert the video media content from the raster-graphics format to a storage format, such as a vector-graphics format. For example, the first controller 110 may execute the first codec 106 to convert video media content from a raster-graphics format to a storage format. The video media content, encoded in the storage format, may be stored in the first storage 108.

At a subsequent point in time, the encoded video media content may be provided to the second computing device 104. For example, a user of the second computing device 104 may have requested the encoded video media content for playback via the network connection 122. The encoded video media content is provided from the first communication interface 112 to the second communication interface 120 via the network connection 122, such that the encoded video media content is accessible to the second computing device 104.

The second codec 114 may decode the encoded video media content for playback to a user by converting the encoded video media content from the storage format to a playback format. For example, the second controller 118 may execute the second codec 114 to convert encoded video media content from a storage format to a playback format. In various examples, the second computing device 104 may be capable of rendering the encoded video media content without requiring a separate plugin. The second computing device 104 may inherently be capable of rendering the encoded video media content. For example, the second computing device 104 may be a mobile electronic phone or other user electronic device sold with vector-graphics rendering functionality that is capable of rendering encoded video media content generated pursuant to the examples disclosed herein. The decoded video media content may then be provided to a user, such as via a display (not illustrated) coupled to the second computing device 104. In various examples, the encoded video media content may have a smaller information size than that of the video media content uploaded in the raster-graphics format. Accordingly, a reduction in information transfer size via the network connection 122 is achieved as compared to the uploaded video media content being provided in the raster-graphics format via the network connection 122. The codecs 106, 114 may enable reductions in information transfer sizes by facilitating the conversion of media content, such as video media content, to a vector-graphics format.

FIG. 2 illustrates a process 200 of converting at least a portion of media content from a first format (for example, a raster-graphics format) to a second format (for example, a vector-graphics format) according to an example. The process 200 may be executed by a controller, such as the first controller 110, executing a codec, such as the first codec 106, to convert video media content from a raster-graphics format to a vector-graphics format. For example, the process 200 may be executed responsive to, or otherwise subsequent to, receiving input video media content including a plurality of frames from an upload source.

At act 202, the process 200 begins.

At act 204, scenes in the video media content are detected. A “scene” may refer to a sequence of continuous, thematically related acts or interactions in a video. For example, the video media content may be a film, and a first scene may include two characters having a conversation. The first scene may end, and a second scene may begin, when the video transitions from the two characters having a conversation to a third character driving a vehicle. Act 204 therefore includes detecting and parsing out these different scenes.

For example, act 204 may include executing a frame correlation operation. More particularly, the frame correlation operation may include determining, for each successive pair of frames, a scalar sum of pixel differences between the two frames. In some examples, the frame correlation operation may include determining a grayscale representation of two successive frames, converting each frame to a one-dimensional linear array of grayscale values, calculating a dot product of the two successive frames, and dividing the dot product by the norms of the two arrays. Mathematically, the correlation operation may be expressed as,

$$Correlation ( {Image}_{1} , {Image}_{2} ) = \frac{{Image}_{1} \cdot {Image}_{2}}{\vert {Image}_{1} \vert \vert {Image}_{2} \vert}$$

where Image₁ and Image₂ each refer to one of two successive frames, and the correlation operation yields a difference in pixel values between the two images.

A significant increase in pixel differences between two successive frames may correspond to a change in scene, because the two successive scenes may be in entirely different environments represented by significantly different pixel values, thereby yielding larger sums of pixel differences.

After executing the frame correlation operation to determine a correlation between images expressed as a difference in pixel values, a threshold may be applied to parse out different scenes. For example, a pixel difference sum exceeding the threshold may correspond to a change in scenes. In some examples, a threshold may be determined by determining a moving average of frame correlations across multiple successive pairs of frames. The threshold may be set to a value above the moving average. For example, the value may represent a tolerance or standard deviation from the moving average, outside of which a pixel difference is sufficiently large relative to the moving average that it is statistically likely that a scene-change has occurred. The threshold may be implemented with hysteresis by temporarily increasing after a scene change is detected such that consecutive frames of a single scene transition are not erroneously detected as multiple scenes. Alternatively or in addition, the hysteresis feature may function to demarcate frames between the last frame of one scene with the first frame of a subsequent scene as a “transition period,” (for example, a series of solid-black frames) which may or may not be considered a separate scene and may or may not be vectorized. In other examples, the frames of the transition period may be part of one or both of the scenes before or after the transition period, such that the transition period is part of a scene.

A pair of frames corresponding to the frame correlation values exceeding the threshold may be demarcated as the last and first frames in two separate scenes. In other examples, act 204 may include analyzing mean pixel intensity (for example, to identify transitions between scenes, such as fade-ins and fade-outs) and/or homography, as discussed in greater detail below, to detect separate scenes.

At act 206, a determination is made as to whether each scene is vectorizable. For example, executing act 206 for a first time may include determining whether a first scene of the scenes detected at act 204 is vectorizable. As used herein, “vectorizable” refers to the comparative advantage of converting a unit of content (for example, a scene in the video media content) to a vector-graphics format. Although a unit of content may be physically capable of being converted to a vector-graphics format, the unit of content may be considered not vectorizable if doing so would degrade a quality of the scene below a threshold quality, for example, or would require more storage or system resources than an alternative format, such as rasterized content.

If the scene is not considered to be vectorizable (206 NO), then the process 200 continues to act 208. At act 208, a scene under consideration is incremented to a subsequent scene, and the process 200 returns to act 206 to consider the vectorizability of the subsequent scene. For example, if a first scene in the video media content is not vectorizable, then the process 200 may proceed to execute a determination as to whether a second, subsequent scene in the video media content is vectorizable, and so forth, until a vectorizable scene is identified. Non-vectorizable scenes may be encoded in accordance with an alternate format, such as h264 encoding. If a vectorizable scene is identified (206 YES), then the process 200 continues to act 210.

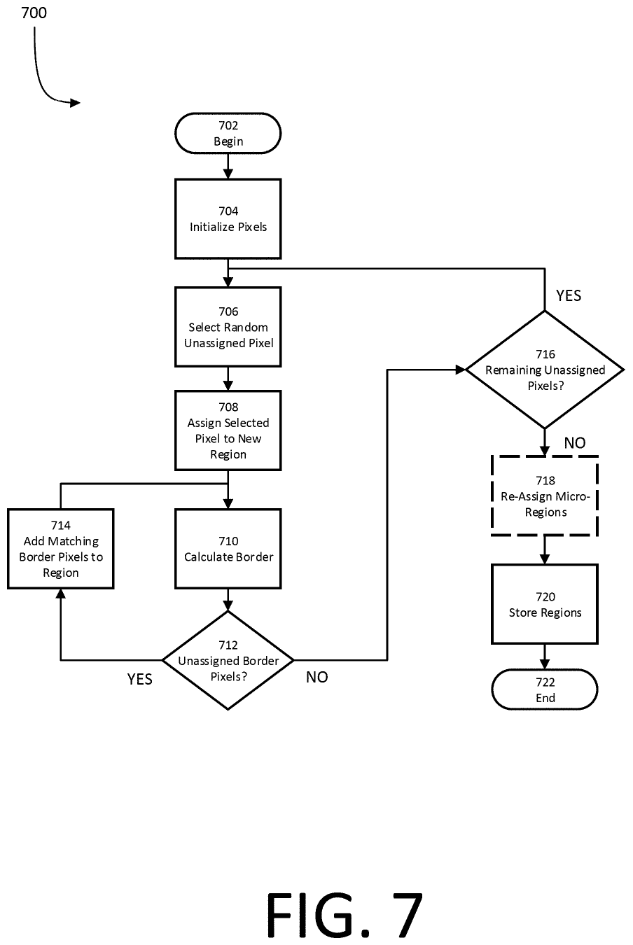

At act 210, objects in the vectorizable scene are segmented. As used herein, “objects” refer to the distinct entities represented in each scene. For example, a scene including a character speaking may include several objects including the character's face, each article of the character's clothing, a wall behind the character, and so forth. Act 210 may include executing various object detection operations including, for example, edge detection, region growing, and so forth. An example of act 210 is discussed in greater detail below with respect to FIG. 7.

At act 212, layers in the vectorizable scene are detected. In various examples, scenes may include at least one first layer superimposed on at least one second layer. For example, a presentation slide may include text superimposed over a slide background. Act 212 includes detecting these separate, distinct layers. In one example, act 212 includes estimating a number of pixels in each object segmented at act 210 (for example, by filling all holes in each object, such as by executing a flood fill operation, and detecting a number of pixels of each object after filling the holes in each objects), and ranking the objects by the corresponding number of pixels. Higher numbers of pixels correspond to objects in a background, because background objects tend to occupy larger portions of a scene and are therefore farther back in a “stack” of the layers. Conversely, layers having lower numbers of pixels tend to be farther forward in the stack of layers.

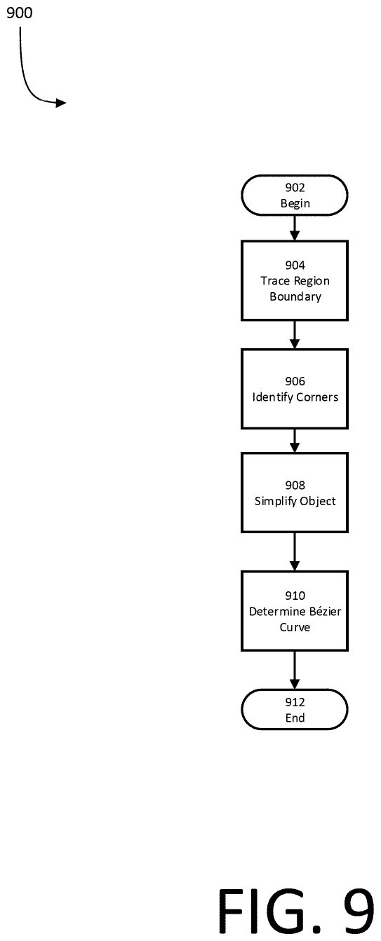

At act 214, images are traced. Tracing an object may include tracing an outline, or the edges, of an object. Tracing the edges of an object facilitates vectorization of the object at least because determining the edges of the object enables the traced edges to be converted to a vector representation more easily. Act 214 may include tracing an object represented in a raster-graphics format to produce traced edges and representing the traced edges in a vector-graphics format. An example of act 214 is discussed in greater detail below with respect to FIG. 9.

At act 216, object movement and rotation are tracked. Throughout a scene, certain objects may move and/or rotate. For example, a character's face may move and/or rotate between frames in a scene as the character speaks. Act 216 thus includes tracking each object in a scene from one frame to the next, and so forth, throughout a scene, and calculating movement and/or rotation of each object throughout the successive frames. More particularly, act 216 may include executing a matching process to identify the same object throughout each successive pair of frames, and calculating a translation and/or transformation vector to quantify object movement and/or rotation throughout a scene.

A matching process may include determining, for each object in a frame segmented at act 210, a correlation between the respective object and each individual object in a subsequent frame. An object in the second frame corresponding to a highest correlation with the respective object may be determined to be the same object, albeit having moved and/or rotated relative to the respective frame. For example, the matching process may include a template-matching method in OpenCV.

Once a corresponding object has been identified for each object in each pair of successive frames in a scene, a translation and/or transformation vector relating each pair of objects may be determined for each pair of objects. For example, a fast Fourier transform (FFT)-based process may be executed to determine at least one vector representing a translation (that is, a movement) of each object from one frame to the next, and/or a rotation of each object from one frame to the next. Translation vectors for each object for each pair of frames in a scene may be subsequently concatenated to represent the respective object's complete movement and/or rotation over time throughout a scene.

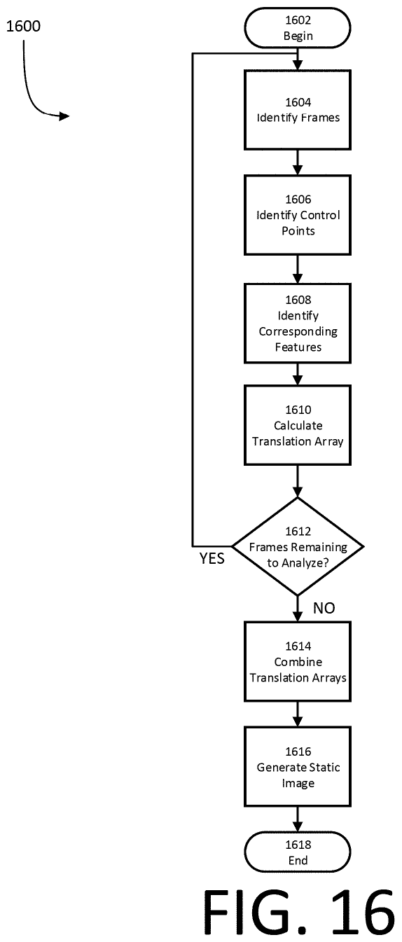

At act 218, background objects are identified. In various examples, objects in a scene may be divided at least into background objects and foreground objects. For example, in a scene depicting a character speaking in front of a wall, the character may include or be treated as a foreground object, and the wall may include or be treated as a background object. Although a view of a scene may pan or zoom throughout the scene, the background object itself may not change. That is, while different portions of the background object are shown throughout the scene, the background object may not itself be translated, rotated, or morphed. Because the background object is not translated, rotated, or morphed, it may not be necessary to render the background object for every scene. Rather, a background object can be rendered once and, if there is panning or zooming throughout a scene, different portions of the background object can be shown without requiring re-rendering of the background object in each frame. Examples of act 218 are provided below with respect to FIG. 16.

At act 220, object morphing is determined. As a scene progresses, various objects may morph between frames. In an example in which a character's face is an object, for example, the character's face may morph throughout a scene as the character speaks, thereby morphing the object representing the character's face. For example, the character's mouth may move as the character speaks. Accordingly, for each object in a scene, a determination may be made as to how each object morphs throughout a scene. In various examples, an initial state of each respective object (for example, indicated by a first frame in a scene in which the object appears) and an ending state of the respective object (for example, indicated by a last frame in the scene in which the object appears) may be captured, and a conventional morphing algorithm may be executed to determine or interpolate the morphing of the object from the initial state to the ending state. In some examples, intermediate states of the respective object (for example, indicated by a frame in which the respective object appears between the first frame and the last frame) may also be used to determine the morphing of the object.

At act 222, objects and transformations for the scene under consideration are recorded. More particularly, each object identified in a scene is recorded, and information indicative of the transformation that the object undergoes throughout the scene is recorded. Recording each object and the transformation that each object undergoes may include storing information indicative of the objects and transformations in storage. The stored objects and transformations may therefore represent each scene by individually representing each element (that is, object) throughout the scene.

As discussed above, acts 210-222 are executed on a single scene determined at act 206 to be vectorizable. However, the video media content may include multiple scenes. Accordingly, at act 224, a determination is made as to whether there are additional scenes to analyze from the scenes detected at act 204. If there are additional scenes to analyze (224 YES), then the process 200 continues to act 208. At act 208, a scene under consideration is incremented to a subsequent scene. The process 200 then returns to act 206 to consider the vectorizability of the subsequent scene. The process 200 continues until a determination is made that there are no additional scenes to be analyzed (224 NO), at which point the process 200 continues to act 226.

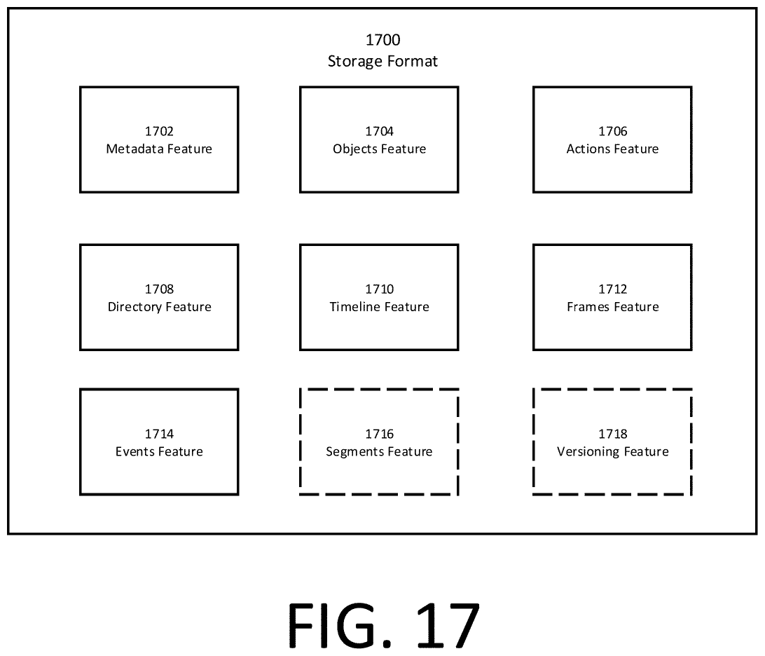

At act 226, the information determined for each scene is compiled and encoded in a storage format. As discussed above, the first codec 106 may suggest, select, or otherwise indicate a particular storage format for the information to be stored in. A storage format of the information determined by the process 200 is discussed in greater detail below with respect to FIG. 17.

At act 228, the process 200 ends.

Accordingly, the process 200 may be executed to encode input video media content in a storage format indicated by a codec. For example, the first computing device 102 may execute the process 200 (for example, using the first controller 110 and the first codec 106) to encode an input raster-graphics format video in a storage format indicated by the first codec 106. The encoded video media content may be stored (for example, in the first storage 108) for later playback, or may be provided to an external entity, such as the second computing device 104 via the communication interface 112.

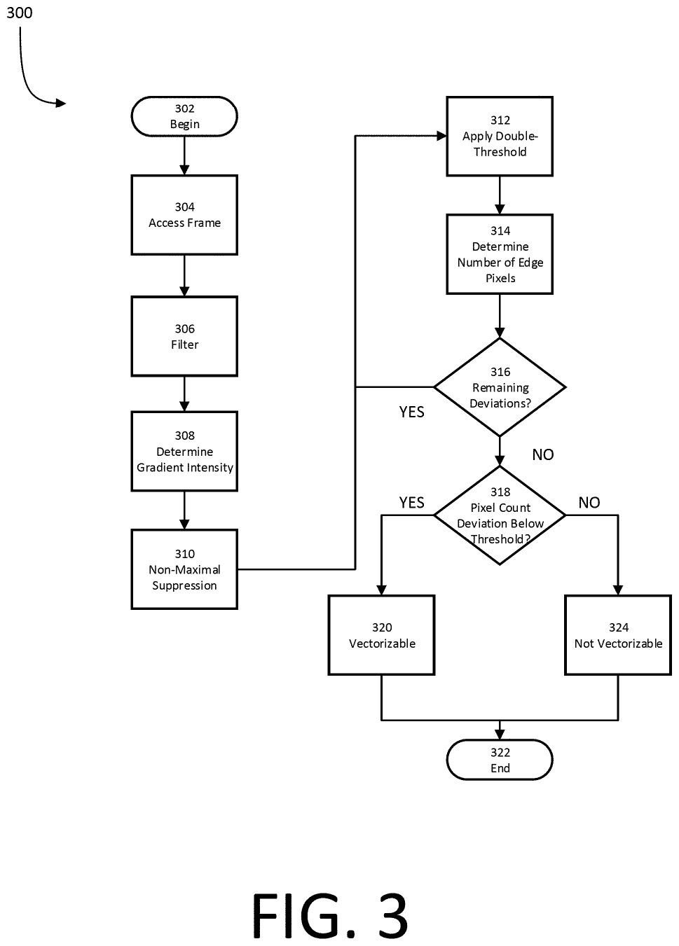

Certain acts of the process 200 will now be discussed in greater detail. As discussed above with respect to act 206, a determination is made for each scene as to whether or not the respective scene is vectorizable. FIG. 3 illustrates a process 300 of determining whether a scene is vectorizable according to an example. The process 300 may be an example of the act 206. In various examples, the process 300 may include execution of a Canny edge detection process, a Laplacian edge detection process, or an alternate edge detection process to identify edges of an object.

At act 302, the process 300 begins.

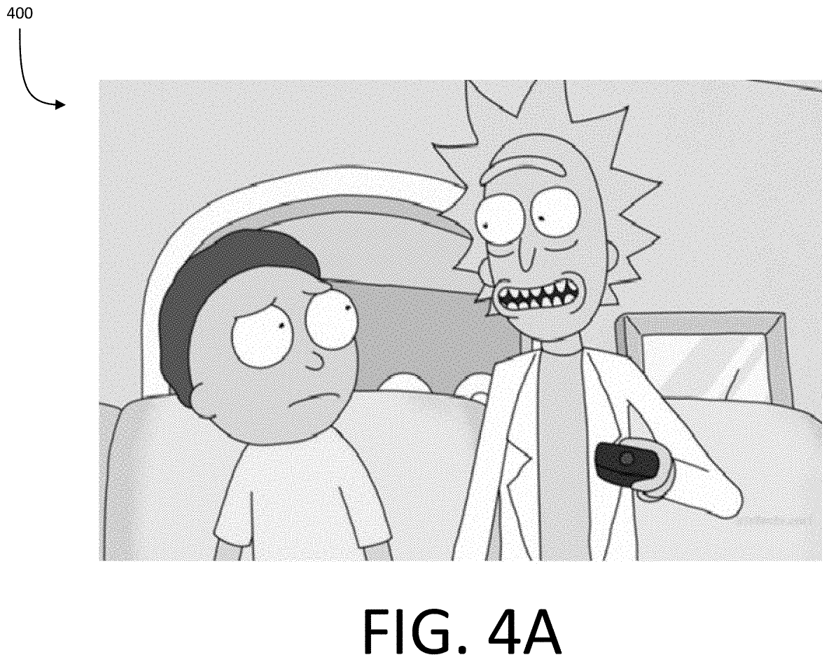

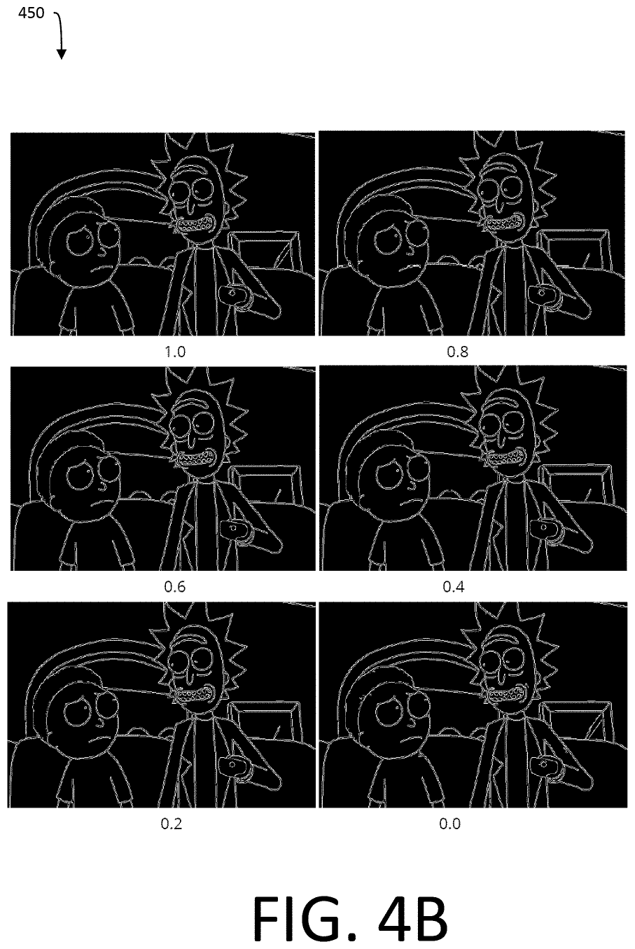

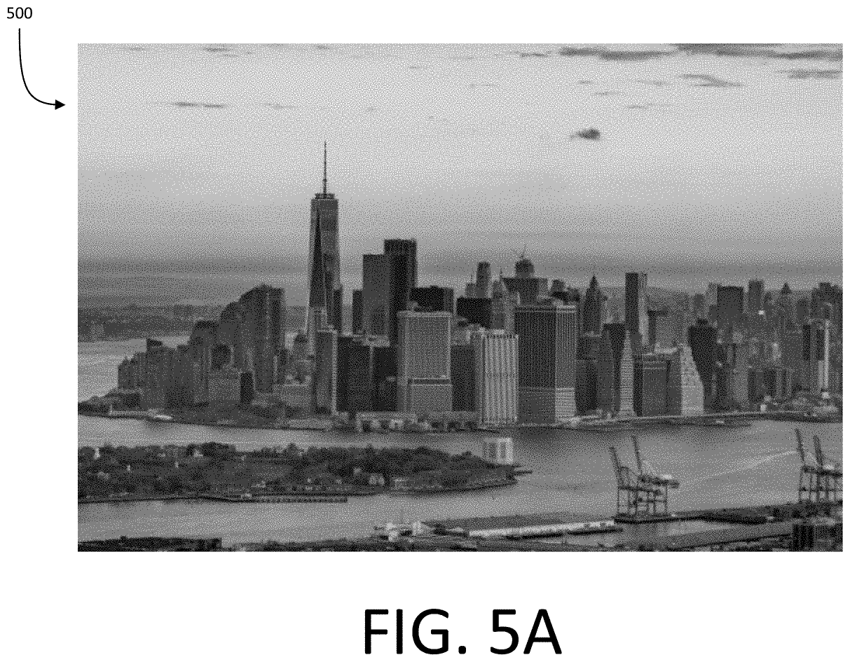

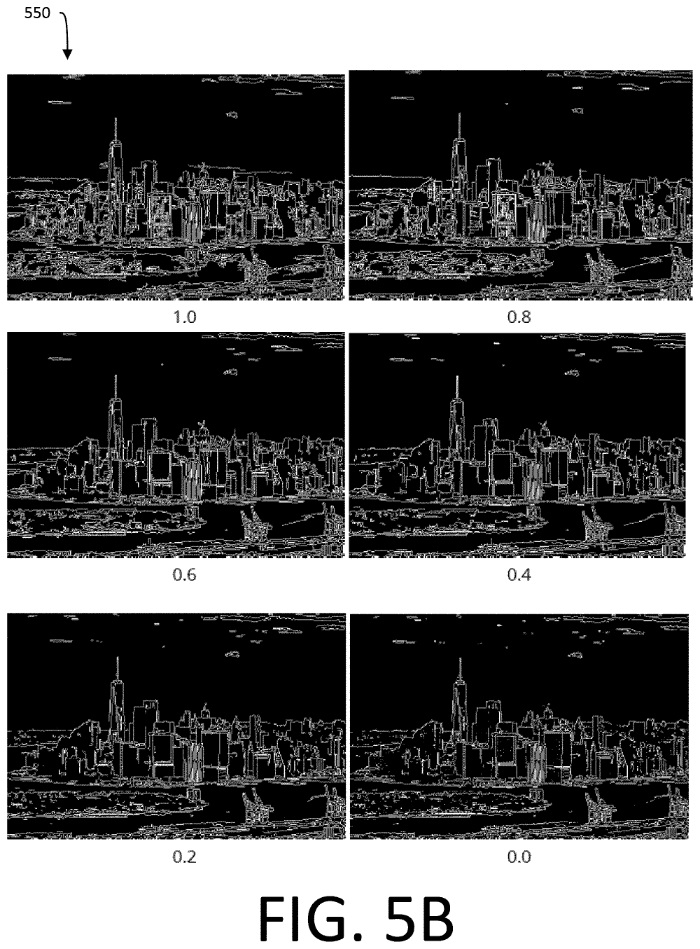

At act 304, a frame in a scene under examination is accessed. For example, the frame may be a first frame in the scene, a randomly selected frame in the scene, a final frame in the scene, or another frame in the scene. The selected frame may be utilized as a representative frame indicative of the scene from which the frame is selected. For example, FIG. 4A illustrates a first image 400 of a first frame extracted from a first scene in a cartoon according to an example. FIG. 5A illustrates a second image 500 of a second frame extracted from a different, second scene in photorealistic video media content (for example, being different than the cartoon) according to an example. As discussed in greater detail below, the first image 400 may represent a frame that is easier to vectorize (for example, because the first image 400 is indicative of a cartoon, which is easier to vectorize), whereas the second image 500 may represent a frame that is harder to vectorize (for example, because the second image 500 is extracted from photorealistic media content, which is harder to vectorize).

At act 306, the frame is filtered. For example, a Gaussian filter may be executed on the frame to filter noise out from the frame. Executing the Gaussian filter may include convolving a Gaussian filter kernel with the frame to reduce the effects of noise on the frame.

At act 308, a gradient intensity of the frame is determined. For example, an edge detection operator may be executed to determine values indicative of gradients in a horizontal and vertical dimension of the frame. The values indicative of the gradients in the horizontal and vertical dimensions of the frame may be utilized to identify objects' edges throughout the frame.

At act 310, a non-maximal suppression operation is performed on the frame. Non-maximal suppression is an edge-thinning technique in which extraneous edges are removed to sharpen edges (that is, by removing blurriness) identified at act 308. For example, act 310 may include identifying local maxima of gradients determined at act 308 and removing (that is, suppressing) all gradients other than the local maxima. The remaining local maxima represent the regions most likely to be edges, such that the remaining edges appear sharper without the extraneous edges included.

At act 312, a double-threshold is applied. After execution of act 310, some detected edges may remain that correspond to noise or color variation (that is, false positives) despite being local maxima. Accordingly, act 312 includes filtering out detected edges having relatively low gradient values under the assumption that such gradient values, despite being local maxima, are likely false positives. In one example, a double-threshold process is executed whereby an upper and lower threshold around a selected standard deviation σ of the gradient intensity are implemented, outside of which corresponding edges are determined to be false positives and thus ignored.

Act 312 may be executed several times, each with a different selected standard deviation σ threshold value from a group of standard deviation values to be used as a threshold value. For example, the group of standard deviation values may include 0.0, 0.2, 0.4, 0.6, 0.8, and 1.0. Accordingly, act 312 initially includes selecting a standard deviation from a group of standard deviation values that has not yet been implemented in act 312, and generating an image using the selected standard deviation (for example, 0.0) as a threshold value in a double-threshold operation. In various examples, the generated image is a binary image including pixels of a first value corresponding to detected edge pixels (for example, represented as white pixels falling inside the double-threshold range), and pixels of a second value corresponding to pixels that are not edge pixels (for example, represented as black pixels falling outside the double-threshold range).

At act 314, a number of edge pixels is determined for the image generated at act 312. As discussed above, the number of edge pixels in the image may vary based on a selected standard deviation value implemented in the double-threshold operation. In various examples, a number of edge pixels may increase as the double-threshold range is expanded, because more values will fall within the double-threshold range and thereby be considered edge pixels.

At act 316, a determination is made as to whether any standard deviation values from the group of standard deviation values have not yet been implemented in the double-threshold operation performed at act 312. For example, a group of standard deviation values may include 0.0, 0.2, 0.4, 0.6, 0.8, and 1.0, each of which may need to be implemented in connection with act 312. If any standard deviation values remain to be implemented (316 YES), then the process 300 returns to act 312, whereby act 312 is executed using a standard deviation value from the group of standard deviation values that has not yet been used. Acts 312-316 are repeated until every standard deviation value in the group of standard deviation values has been implemented at act 312 (316 NO), at which point the process 300 continues to act 318.

Once every standard deviation value in the group of standard deviation values has been implemented at act 312 (316 NO), several binary images have been generated for various standard deviation values. For example, FIG. 4B illustrates a first plurality of binary images 450 generated by executing acts 306-316 on the image 400 using various standard deviation values at act 312, including 0.0, 0.2, 0.4, 0.6, 0.8, and 1.0. Similarly, FIG. 5B illustrates a second plurality of binary images 550 generated by executing acts 306-316 on the image 500 using various standard deviation values at act 312, including 0.0, 0.2, 0.4, 0.6, 0.8, and 1.0.

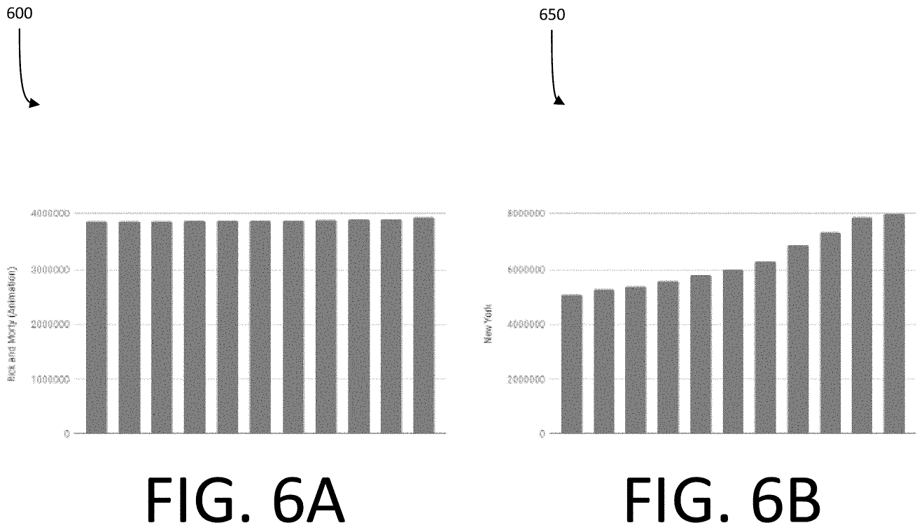

A relationship between the selected standard deviation σ and the number of edge pixels is illustrated in connection with FIGS. 6A and 6B. FIG. 6A illustrates a first graph 600 including a y-axis indicative of an edge pixel count for the first plurality of binary images 450, and an x-axis indicative of a selected gradient standard deviation value. Similarly, FIG. 6B illustrates a second graph 650 including a y-axis indicative of an edge pixel count for the second plurality of binary images 550, and an x-axis indicative of a selected gradient standard deviation value.

In both the first plurality of binary images 450 and the second plurality of images 550, increasing the standard deviation value generally corresponds to higher numbers of edge pixels, which may include additional false positive edges, as indicated by the first graph 600 and the second graph 650. However, a proportional increase in the number of edge pixels in the first plurality of images 450 is lower than a proportional increase in the number of edge pixels in the second plurality of images 550, as indicated by the higher slope in the second graph 650 than that of the first graph 600.

This may indicate that the first image 400 is more amenable to vectorization than the second image 500, because edges may be detected with more certainty and with fewer false positives. Accordingly, quantifying a proportional increase in a number of edge pixels as a function of a selected gradient standard deviation may be executed to determine if an image is vectorizable.

At act 318, a determination is made as to whether a standard deviation of an edge pixel count as a function of a gradient standard deviation is below a threshold. If an edge pixel count does not increase significantly as the gradient standard deviation is increased, as with the first image 400 as indicated by the first graph 600, then the standard deviation of the edge pixel count as a function of the gradient standard deviation may be relatively low. If the standard deviation of the edge pixel count as a function of the gradient standard deviation is below a threshold value (318 YES), such as a threshold value of 0.5, then the process 300 continues to act 320. At act 320, the image, and the scene from which the scene was accessed at act 304, is considered to be vectorizable. The process 300 then ends at act 322.

Conversely, if the standard deviation of the edge pixel count as a function of the gradient standard deviation is above the threshold value (318 NO), such as a threshold value of 0.5, then the process 300 continues to act 324. At act 324, the image, and the scene from which the scene was accessed at act 304, is considered to be not vectorizable. The process 300 then ends at act 322.

Accordingly, the process 300 may be executed to determine if a scene is vectorizable. Determining if a scene is vectorizable includes selecting a representative frame and determining a sensitivity of a number of identified edge pixels to increases in a gradient standard deviation value. Generally speaking, scenes are considered more vectorizable if the number of identified edge pixels is relatively insensitive to increases in the gradient standard deviation value, because such scenes may be considered to have robust edges relatively insensitive to false positives. The edges may therefore be determined with greater certainty, thereby facilitating vectorization.

As discussed above with respect to act 210, objects in a frame may be segmented and separately identified for each scene. An example of segmenting objects in a frame, which may be an example of act 210, is described with reference to FIG. 7.

FIG. 7 illustrates a process 700 of segmenting objects in a frame according to an example. The process 700 may be executed with respect to each frame in a scene under examination. As discussed in greater detail below, the process 700 includes gradually assigning each pixel in a frame to a region, where each resulting region will be identified as a separate object.

At act 702, the process 700 begins.

At act 704, pixels in the frame are initialized. Initializing the pixels may include marking each pixel in the frame as not corresponding to any region.

At act 706, a random pixel not assigned to any region is selected. Where act 706 is first executed after executing act 704, a random pixel may be selected from all of the pixels in the frame, because all of the pixels in the frame are indicated as not being assigned to any region.

At act 708, the selected pixel is assigned to a new region. For example, where act 708 is first executed, a new region (for example, a “First Region”) may be generated, and may be defined as including the selected pixel. In another example, where act 708 is executed a second time, a new region (for example, a “Second Region”) distinct from the First Region may be generated, and may be defined as including the selected pixel, and so forth for each subsequent execution of act 708.

At act 710, a border of the region to which the selected pixel is assigned is determined. The border of the region to which the selected pixel is assigned includes any pixels that are outside of the assigned region, and which are separated by one pixel in a horizontal, vertical, or diagonal dimension from any pixel in the assigned region. That is, the border includes any pixels that are directly adjacent to pixels in the assigned region and which are not themselves already in the assigned region. For example, where the assigned region includes only one pixel (that is, the selected pixel), the border includes the eight directly adjacent pixels, including two horizontal pixels to the left and right of the selected pixel, two vertical pixels above and below the selected pixel, and four diagonal pixels, each at a respective one of the four corners of the selected pixel.

At act 712, a determination is made as to whether any pixels bordering the region to which the selected pixel is assigned (also referred to as “border pixels”) have yet to be assigned to a region. If there are border pixels that have not yet been assigned to a region (712 YES), then the process 700 continues to act 714. For example, where act 712 is first executed, none of the border pixels may be assigned to a region, because only the selected pixel is assigned to a region.

At act 714, border pixels that match the region to which the selected pixel is assigned are added to the region. A match may be identified where a border pixel has a similar color as the region. For example, a match may be identified where a weighted distance between a color of the border pixel and a color of the region is within a specified value (for example, 15) on a scale of color values (for example, ranging from 0 to 255). That is, in one example, a match may be found between a region having a color value of 100 and any border pixel having a color value between 85 and 115. In various examples, the weighted distance between the color of the border pixel and the color of the region may be determined in the YUV colorspace, and a four-times emphasis may be placed on the Y-channel. In some examples, a color of the region may be determined based on the color(s) of the pixels comprising the region. For example, the color of the region may be an average color of the pixels in the region.

Once matching pixels have been added to the region, the process 700 continues to act 710, at which point a border is re-calculated. The border may expand where additional pixels have been added to the region. In some examples, however, the border may not expand even where additional pixels have been added to the region. For example, the border may not expand where any newly added pixels do not border any unassigned pixels that were not already border pixels prior to adjusting the region at act 714. Accordingly, determining the border at act 710 may or may not yield an updated border.

Returning to act 712, if there are no unassigned border pixels (712 NO), then the process 700 continues to act 716. In various examples, act 712 may implement hysteresis. For example, if an unassigned border pixel is determined not to match a region at act 714, then a subsequent execution of act 712 may ignore the previously analyzed unassigned border pixel because the unassigned border pixel has already been determined to not match a color of the region.

At act 716, a determination is made as to whether any unassigned pixels (that is, pixels not assigned to a region) remain in the frame. If any unassigned pixels remain in the frame (716 YES), then the process 700 returns to act 706. Acts 706-716 may be repeatedly executed until every pixel in the frame is assigned to a region. If every pixel has been assigned to a region (716 NO), then the process 700 may continue to optional act 718, or may continue directly to act 720 if act 718 is not executed.

At optional act 718, pixels in micro-regions may be re-assigned to other regions. As used herein, a “micro-region” refers to regions including a number of pixels that is below a threshold value. For example, a micro-region may include any region including fewer than 20 pixels. Micro-regions may be re-assigned to a neighboring region that is not a micro-region, such as a neighboring region having a closest weighted color value to the micro-region Eliminating micro-regions may be advantageous to avoid identifying groups of pixels which are too small to be properly identified as separate regions, and which should be included in neighboring regions. In other examples of the process 700, optional act 718 is not executed, and micro-regions are not altered.

At act 720, regions are stored. For example, where optional act 718 is executed, act 720 may include storing every region remaining after execution of act 718. In examples in which optional act 718 is not executed, act 720 may include storing every region identified after every pixel has been assigned to a region (716 NO).

At act 722, the process 700 ends.

Accordingly, the process 700 may be executed to identify one or more distinct regions of pixels in a frame. As discussed above, each region may correspond to a separate object. That is, in these examples, a “region” may be used interchangeably with an “object.” For example, in a frame including a character speaking in front of a wall, a first region may correspond to a first object, such as the character's face, a second region may correspond to a second object, such as the character's shirt, a third region may correspond to a third object, such as the wall in the background, and so forth. Thus, execution of the process 700 enables each object in a frame to be identified and separately stored.

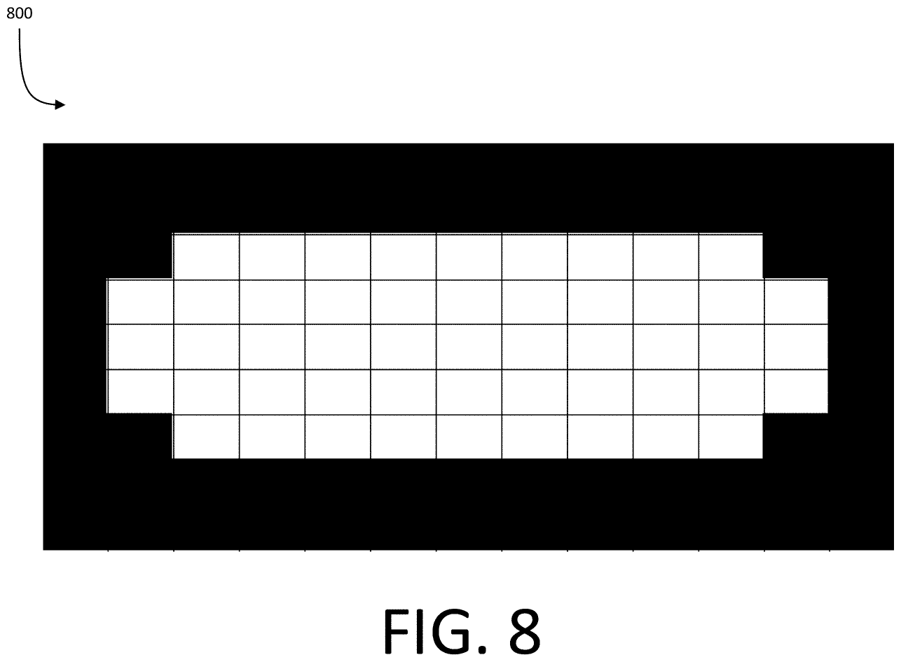

As discussed above with respect to act 214, tracing an object may include tracing an object in a raster-graphics format to produce traced edges, and representing the traced edges in a vector-graphics format. For example, FIG. 8 illustrates a schematic view of an object 800 represented in a raster-graphics format and including several pixels. Act 214 may include tracing the edges of objects, such as the object 800, to facilitate vectorization of the objects.

FIG. 9 illustrates a process 900 of tracing objects for vectorization according to an example. The process 900 may be executed with respect to objects such as the object 800 to trace the edges thereof, and to subsequently represent the object in a vector-graphics format. In various examples, the process 900 may be an example of act 214.

At act 902, the process 900 begins.

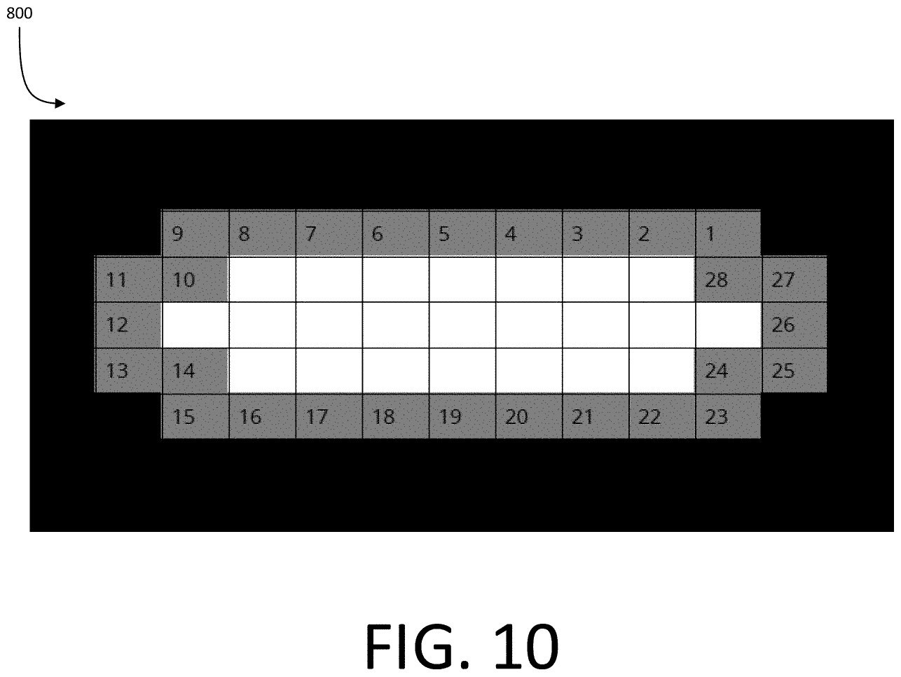

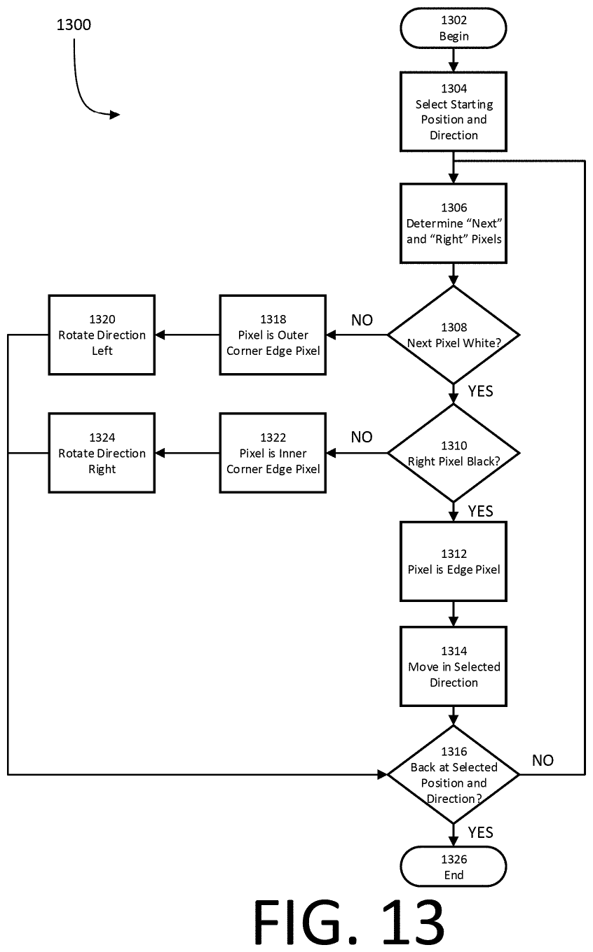

At act 904, edge pixels are identified. Edge pixels may include pixels that are directly adjacent to at least one pixel not within the object. Directly adjacent pixels may include pixels in any of a horizontal, vertical, or diagonal direction from a pixel under consideration. For example, FIG. 10 illustrates a second schematic view of the object 800 according to an example, in which each of the edge pixels of the object 800 have been identified and enumerated. An example of executing act 904 is provided below with respect to FIG. 13.

At act 906, object corner pixels are identified from the edge pixels. Corner pixels may include each pixel for which a line connecting the respective pixel to a first adjacent edge pixel is not parallel to a second adjacent edge pixel. For example, in FIG. 10, pixel 1 is a corner pixel because a line connecting pixel 1 to pixel 2 is horizontal, whereas a line connecting pixel 1 to pixel 28 is vertical. Accordingly, in FIG. 10, corner pixels of the object 800 include pixel 1, pixel 9, pixel 10, pixel 11, pixel 13, pixel 14, pixel 15, pixel 23, pixel 24, pixel 25, pixel 27, and pixel 28. As discussed in greater detail below with respect to FIG. 13, which may provide an example of act 904, act 904 may include identifying edge corner pixels as outer corner edge pixels or inner corner edge pixels.

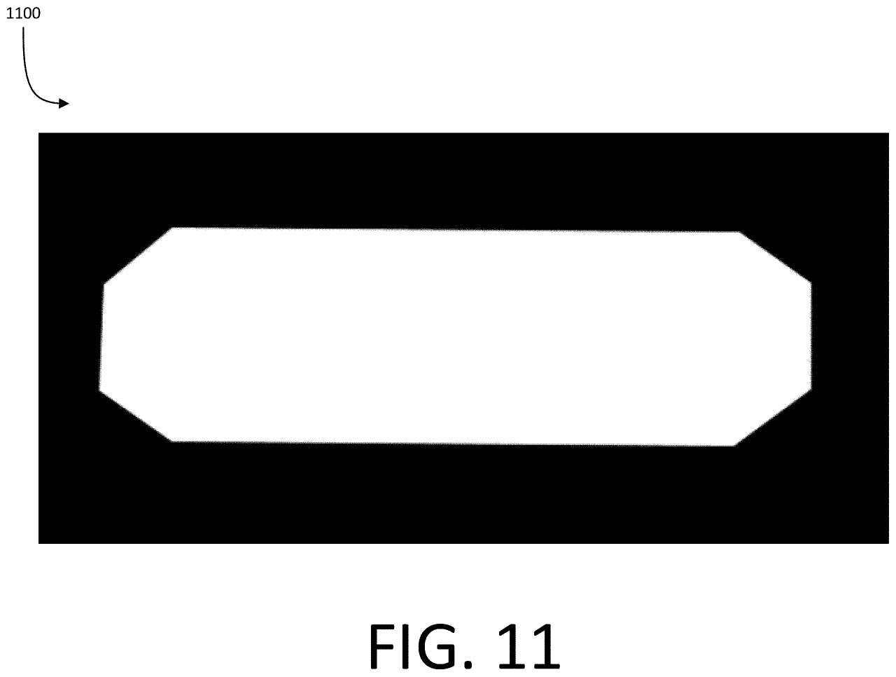

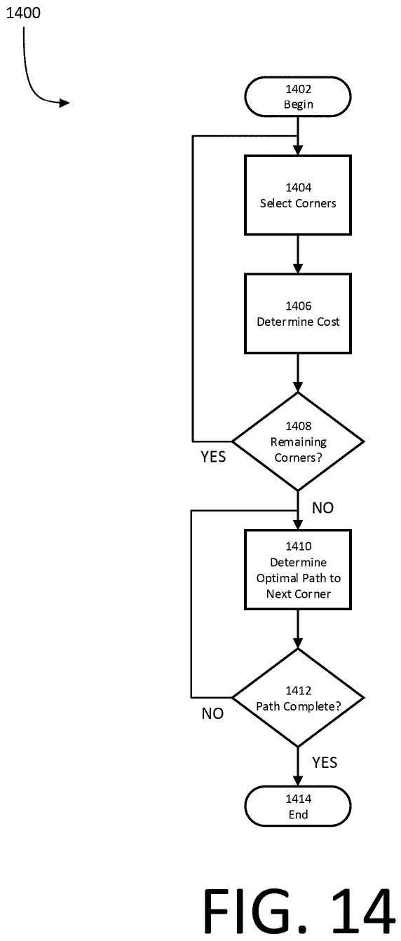

At act 908, an object is simplified. Simplifying an object may include altering a shape of an object to a form that is more easily converted to a vector representation. More particularly, simplifying an object may include identifying and removing redundant corner pixels, and determining an optimal route between the remaining corner pixels. For example, FIG. 11 illustrates a schematic view of a simplified object 1100 according to an example, where the simplified object 1100 may be a simplified version of the object 800. An example of executing act 908 is discussed in greater detail below with respect to FIG. 14.

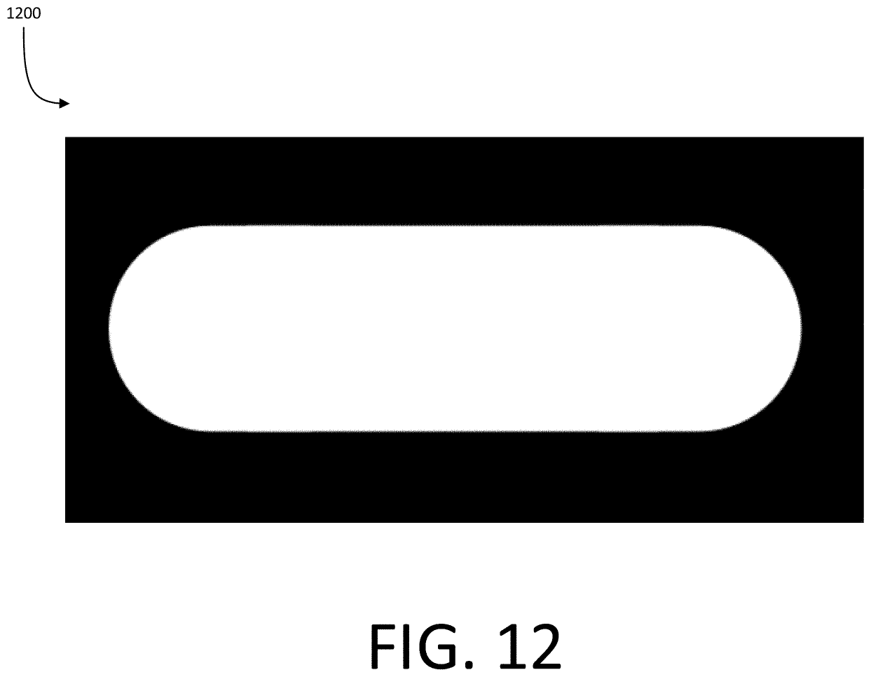

At act 910, one or more Bézier curves representing the simplified object are determined. Determining the one or more Bézier curves may include executing a conventional Bézier curve substitution algorithm to generate a representation of the simplified object using Bézier curves. For example, FIG. 12 illustrates a schematic view of a modified object 1200 according to an example. The modified object 1200 represents an example of the simplified object 1100 subsequent to executing act 910 and determining one or more Bézier curves representing the simplified object 1100.

At act 912, the process 900 ends.

Accordingly, the process 900 may be executed to trace the edges of an object in a raster-graphics format and represent the object with one or more Bézier curves. Objects represented by Bézier curves may be vectorized more easily than objects represented by a raster-graphics format, for example, because vector-graphics formats represent objects in terms of a collection of parameters representing curves. Although a shape of the object may be altered, the altered object may be sufficiently similar to the unaltered object as to be substantially indistinguishable from the unaltered object from a human viewer's perspective. For example, and as discussed above, a scene including the object may have already been determined to be amenable to vectorization (for example, at act 206) for the process 900 to be executed with respect to the object 800. The process 900 thus enables objects represented in a raster-graphics format to be represented in a vector-graphics format.

As discussed above, act 904 includes identifying edge pixels. FIG. 13 illustrates a process 1300 of identifying edge pixels according to an example, and may be an example of act 904. In various examples, reference is made to the object 800 in FIG. 10 for purposes of explanation.

At act 1302, the process 1300 begins.

At act 1304, a starting position and direction are selected. A position may refer to a point between up to four adjacent pixels, that is, a point at which the points of four adjacent pixels meet, or any point at a corner of any pixel. A direction may refer to a direction that is left, right, up, or down from the selected position. As discussed in greater detail below, in various examples, an initial selected position may be a rightmost pixel in the topmost row in an object under consideration and pixels may be analyzed in a counterclockwise fashion around an object. In the context of the object 800, a selected position may be a point at the top-right corner of pixel 1, and a selected direction may be left, such that the object 800 may be analyzed in a counterclockwise direction.

At act 1306, a “next” pixel is identified and a “right” pixel is identified. A next pixel is a pixel to the left of an arrow extending from the selected position in the selected direction. For example, where the selected position is at a point at the top-right corner of pixel 1, and the direction is left, the next pixel is pixel 1. Similarly, a right pixel is a pixel to the right of the arrow extending from the selected position in the selected direction. For example, where the selected position is at a point at the top-right corner of pixel 1, and the direction is left, the right pixel is the black pixel directly above pixel 1.

At act 1308, a determination is made as to whether the next pixel identified at act 1306 is white. In the example discussed above, the next pixel is pixel 1, which is white. In this example, a determination is made that the next pixel is white (1308 YES). It is to be appreciated that, as used herein, “white” pixels refer to pixels with an object under examination, and “black” pixels refer to pixels not within an object under examination. No limitation is meant to be implied by specific colors of the pixels. If a determination is made that the next pixel is white (1308 YES), then the process 1300 continues to act 1310. Otherwise, if the determination is made that the next pixel is not white (1308 NO), and therefore black, the process 1300 continues to act 1318.

At act 1310, a determination is made as to whether the right pixel identified at act 1306 is black. In the example discussed above, the right pixel is the black pixel directly above pixel 1. Accordingly, in this example, a determination is made that the right pixel is black (1310 YES), and the process 1300 continues to act 1312. In examples in which the right pixel is not black (1310 NO), and therefore white, the process 1300 continues to act 1322.

At act 1312, the next pixel is identified as an edge pixel. As discussed above, edge pixels include pixels that are directly adjacent to pixels outside of an object. In the example discussed above, the next pixel is pixel 1, which is identified as an edge pixel. As discussed in greater detail below, pixel 1 may be further identified as an outer corner edge pixel.

At act 1314, the selected position is incremented in the selected direction. For example, in the examples discussed above in which the selected position is at the top-right corner of pixel 1 and the selected direction is to the left, incrementing the selected position includes moving the selected position to the left by the distance of one pixel. Accordingly, after act 1314, the selected position is at the top-left corner of pixel 1. The selected direction is not altered at act 1314, and therefore remains to the left.

At act 1316, a determination is made as to whether a current position and direction are back to the starting selected position and selected direction. In the examples discussed above, the starting selected position and selected direction correspond to the top-right corner of pixel 1, directed to the left. Where act 1314 includes moving the selected position to the top-left corner of pixel 1, as in the examples discussed above, a determination is made at act 1316 that the current position and direction are not back to the selected position and selected direction (1316 NO) because, although the current direction is left, the selected position has moved. Accordingly, the process 1300 returns to act 1306. In other examples, in which a determination is made that the current position and direction are back to the selected position and selected direction (1316 YES), the process 1300 continues to act 1326.

Returning to act 1306, a determination is made to identify a new next pixel and a new right pixel. For example, continuing with the example discussed above, the next pixel will be pixel 2, and the right pixel will be the black pixel above pixel 2. Acts 1306-1316 will repeat for pixels 2-9, each of which will be identified as an edge pixel at act 1312, until a current position is at a top-left corner of pixel 9 with a current direction to the left. At this point, both the next pixel and the right pixel are black pixels. At act 1308 in this example, a determination is made that the next pixel is not white (1308 NO). Accordingly, the process 1300 continues to act 1318.

At act 1318, a determination is made that an immediately preceding next pixel (in this example, pixel 9) is an outer corner edge pixel. An outer corner edge pixel is an edge pixel that is on an outer corner (that is, a corner pixel directly adjacent to at least two black, or non-object, pixels) of the object. It is to be appreciated that an outer corner edge pixel (for example, pixel 9) may be identified as both an outer corner edge pixel at act 1318 and as an edge pixel at act 1312.

At act 1320, a current direction is rotated counterclockwise, or left, by 90 degrees. For example, where a current position is at the top-left corner of pixel 9, and a current direction is to the left, act 1320 may include rotating the current direction to be down. The process 1300 then proceeds to act 1316, whereby a determination is made as to whether a current position and current direction are equal to a starting position and direction. The process 1300 continues until a current position is at the top-left corner of pixel 10 and that a current direction is down. In this example, at act 1306, a next pixel is determined to be pixel 10, and a right pixel is determined to be pixel 11.

At act 1308 in this example, a determination is made that the next pixel (that is, pixel 10) is white (1308 YES), and the process 1300 continues to act 1310. At act 1310 in this example, a determination is made that the right pixel (that is, pixel 11) is white (1310 NO). Accordingly, the process 1300 continues to act 1322.

At act 1322, a determination is made that the next pixel (in this example, pixel 10) is an inner corner edge pixel. An inner corner edge pixel is an edge pixel that is on an inner corner (that is, a corner pixel directly adjacent to only one black, or non-object, pixel) of the object. It is to be appreciated that an inner corner edge pixel (for example, pixel 10) may be identified as both an inner corner edge pixel at act 1322 and as an edge pixel at act 1312.

At act 1324, a current direction is rotated to the clockwise by 90 degrees. For example, where a current position is at the top-left corner of pixel 10, and a current direction is down, act 1324 may include rotating the current direction to be to the left. The process 1300 then proceeds to act 1316. The process 1300 continues around the object 800 until a current position is at the top-right corner of pixel 1 and that a current direction is up. In this example, at act 1306, a next pixel and a right pixel are determined to be black. Acts 1308, 1318, and 1320 are executed, whereby pixel 1 is identified as an outer corner edge pixel at act 1318, and a current direction is rotated to be to the left.

At act 1316, a determination is made that both the current position and the current direction match a starting position and direction selected at act 1304 (1316 YES). In the examples provided above, for example, a determination may be made that the current position is at a top-right corner of pixel 1, and that a current direction is to the left. Accordingly, the process 1300 continues to act 1326.

At act 1326, the process 1300 ends.

Accordingly, the process 1300 may be executed to identify edge pixels for an object. More particularly, pixels may be identified as edge pixels, outer corner edge pixels, and/or inner corner edge pixels. Identification of edge pixels may be advantageous in, for example, simplifying and vectorizing an object, as discussed above with respect to acts 908 and 910.

For example, an example of simplifying an object at act 908 is provided below with respect to FIG. 14. FIG. 14 illustrates a process 1400 of simplifying an object according to an example. For example, as discussed above with respect to FIG. 9, the process 1400 may be executed in connection with the object 800 to simplify the object 800. Simplifying the object 800 may include identifying an optimal route around the edge pixels of the object 800.

At act 1402, the process 1400 begins.

At act 1404, a pair of corners is selected. As discussed above, in some examples act 904 may include identifying edge pixels (for example, in examples in which act 904 includes the process 1300), and further identifying edge pixels as outer corner edge pixels or inner corner edge pixels. Act 1404 includes selecting two corner pixels which have not yet been selected from a group of pixels including the outer corner edge pixels and inner corner edge pixels. For example, and with reference to the object 800, the pair of corner pixels may include pixel 1 and pixel 9.

At act 1406, a cost between the selected pair of pixels is determined. A straight line connecting the pair of pixels is determined, and a cost is determined as a squared value of a distance between the straight line and each edge pixel between the pair of pixels. For example, and with reference to the object 800, a straight line connecting pixel 1 and pixel 9 may be determined, and a cost of the straight line connecting pixel 1 and pixel 9 is determined as a squared distance between the straight line and each edge pixel between pixel 1 and pixel 9.

At act 1408, a determination is made as to whether any pairs of corners remain for which a cost has yet to be determined. For example, and with reference to the object 800, a determination may be made as to whether a cost has been determined for each pair of pixels in a group of corner pixels including pixel 1, pixel 9, pixel 10, pixel 11, pixel 13, pixel 14, pixel 15, pixel 23, pixel 24, pixel 25, pixel 27, and pixel 28. If any pairs of corners remain for which a cost has yet to be determined (1408 YES), then the process 1400 returns to act 1404. Acts 1404-1408 are repeated until a cost between each pair of pixels has been determined (1408 NO), responsive to which the process 1400 continues to act 1410.

At act 1410, an optimal path from a starting pixel to a next pixel is determined. For example, the starting pixel may be a randomly selected one of the corner edge pixels, such as pixel 1 of the object 800, and an optimal path from the selected pixel to itself around the edge pixels of the object 800 is determined. Determining the optimal path includes determining an optimal path from the selected pixel to each successive corner edge pixel. At an initial execution of act 1410, an optimal path from the starting pixel to a first next pixel is a straight line connecting the pair of pixels such as a straight line connecting pixel 1 to pixel 9.

In subsequent executions of act 1410, determining an optimal path may include comparing path costs. More particularly, determining the optimal path may include comparing a cost of a path extending directly from the starting pixel to the next pixel with a sum of a cost of a path extending between the starting pixel and an intermediate pixel and a cost of a path extending between the intermediate pixel and the next pixel. For example, act 1410 may include comparing the cost of a path connecting pixel 1 directly to pixel 11, determined at act 1406, above, to the sum of the cost of a path connecting pixel 1 to pixel 9 and the cost of a path connecting pixel 9 to pixel 11, determined above at act 1406.

If the cost of the path directly connecting pixel 1 and pixel 11 exceeds the sum of the costs of the paths connecting pixel 1 to pixel 11 via pixel 9, then the optimal path is the path connecting pixel 1 to pixel 11 via pixel 9, because the lower-cost path is considered the optimal path. Otherwise, if the cost of the path directly connecting pixel 1 and pixel 11 is less than the sum of the costs of the paths connecting pixel 1 to pixel 11 via pixel 9, then the optimal path is the path connecting pixel 1 directly to pixel 11, because the lower-cost path is considered the optimal path.

At act 1412, a determination is made as to whether the path is complete. The path may be considered complete when the path has returned back to the starting pixel, having traveled completely around the object. If the path is not yet complete (1412 NO), then the process 1400 returns to act 1410. Acts 1410 and 1412 are repeated until a determination is made that the path extending from the starting pixel around the object and back to the starting pixel is complete (1412 YES). Responsive to determining that the path is complete (1412 YES), the process 1400 continues to act 1414.

At act 1414, the process 1400 ends.

Accordingly, the process 1400 provides an example of simplifying objects. For example, the process 1400 may be an example of act 908. The process 1400 may be beneficially executed to simplify objects, such as the object 800, in preparation for vectorization, as discussed in greater detail above.

Returning to FIG. 2, as discussed above, act 218 includes identifying background objects, as distinguished from foreground objects. For example, in a scene including a character speaking in front of a wall, the wall may be a background object. Background objects are often not translated, rotated, or morphed throughout a scene. A scene may pan or zoom, thereby revealing different portions of a background object, but the background object itself may not change. Accordingly, it may only be necessary to render certain background objects once and, as a scene pans or zooms, different portions of the already-rendered background objects may be shown in the scene. Identifying and reconstructing the background objects may be generally referred to as homography. It may be therefore be advantageous to identify background objects to reduce extraneous rendering.

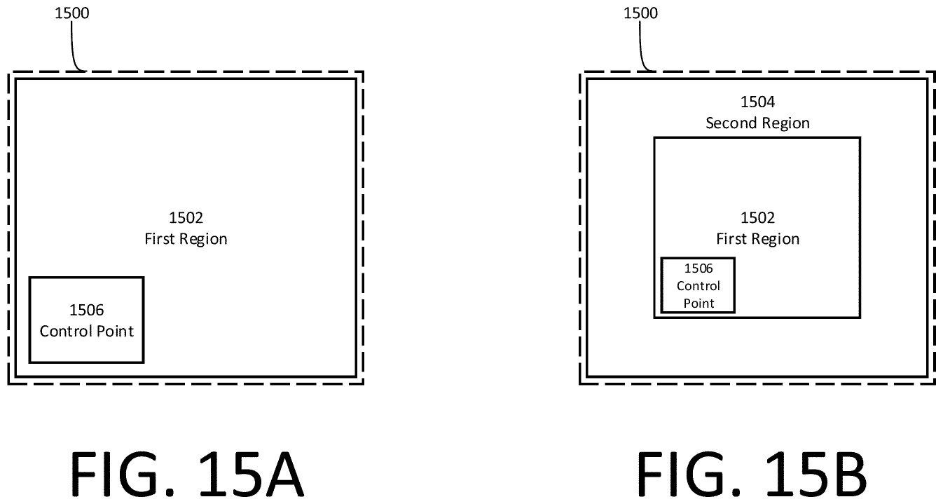

For example, FIG. 15A illustrates a block diagram of a view 1500 in a scene at a first time according to an example. The view 1500 indicates what a user views when a scene is played. At the first time, the view 1500 consists entirely of a first region 1502 which is displayed to a user. Similarly, FIG. 15B illustrates a block diagram of the view 1500 in the scene at a second time according to an example. At the second time, the scene has zoomed out, such that the first region 1502 is still visible in the view 1500 but is now surrounded by a second region 1504 that has become visible in the view 1500 as the scene zooms out. In examples in which the first region 1502 and the second region 1504 both include a background having background objects, it may be advantageous to render the background only once, and display more of the background in the view 1500 as the scene zooms out from the first time to the second time.

FIG. 16 illustrates a process 1600 of identifying background objects according to an example. For example, the process 1600 may be an example of the act 218. Examples of the process 1600 are provided with respect to FIGS. 15A and 15B.

At act 1602, the process 1600 begins.

At act 1604, a pair of frames is identified. For example, two successive frames in a scene may be identified for comparison to determine a degree of homography between the two successive frames. For purposes of explanation, examples are provided in which a first frame is illustrated by FIG. 15A, and a second, successive frame is illustrated by FIG. 15B.

At act 1606, control points in the pair of frames are identified. Control points generally refer to features that are substantially similar between the pair of frames. For example, a particular background or foreground object that appears in both frames may be a control point where the object appears substantially similar between the frames. Objects may not need to be identical to be control points, such as an object that appears in both frames but is somewhat smaller in a second frame which has zoomed out from the first frame.

For example, the first region 1502 includes a control point 1506 that appears in both FIGS. 15A and 15B. The control point 1506 may be substantially similar between FIGS. 15A and 15B, although the control point 1506 appears smaller in FIG. 15B because the scene has zoomed out relative to FIG. 15A.

At act 1608, corresponding features are identified. Corresponding features may include features that are substantially similar between the pair of frames. For example, in FIGS. 15A and 15B, the first region 1502 may be a feature that is common to both FIGS. 15A and 15B. Accordingly, act 1608 may include identifying the first region 1502 as a corresponding feature between FIGS. 15A and 15B. Act 1608 may include executing a descriptor matcher process, such as an OpenCV descriptor matcher function, to identify corresponding features based on the identified control point 1506. In some examples, act 1608 may include executing a feature-matching algorithm, such as an oriented FAST and rotated BRIEF (ORB) or scale-invariant feature transform (SIFT) operation executed in OpenCV.

At act 1610, a translation array is determined for the selected pair of frames. Act 1610 may be substantially similar to determining a translation and/or transformation vector at act 216, above, except that act 1610 is executed on an entire frame instead of an individual object. More particularly, act 1610 may include determining a translation and/or transformation vector relating each pair of successive frames. For example, an FFT-based process may be executed to determine at least one vector representing a translation (that is, a movement) between the frames, a rotation between the frames, and a scale value between the frames. In some examples, act 1610 may include executing a homography operation, such as a random sample consensus (RANSAC) operation.

At act 1612, a determination is made as to whether any frames have not yet been analyzed for a scene. If any frames remain to be analyzed (1612 YES), then the process 1600 returns to act 1604, and acts 1604-1612 are repeated until a determination is made that all frames in a scene have been analyzed. If a determination is made that all frames in a scene have been analyzed (1612 NO), then the process 1600 continues to act 1614.

At act 1614, translation arrays are combined. For example, each translation array determined at act 1610 for a scene may be combined into a single array to quantify movement of a view about a background throughout a scene. Where the background may be identified as a single static image, as discussed below with respect to act 1616, the combined translation array indicates which portions of the background are displayed throughout a scene.

At act 1616, a static image of the background is determined. For example, act 1616 may include implementing an image-stitching process to generate a static image of the entire background. More particularly, the image-stitching process may include combining images of each section of a background object as the various sections of the background object are displayed throughout a scene. Generating the stitched image may be advantageous at least because, as discussed above with respect to act 1614, translation arrays may be combined to quantify which portions of the static image are shown in a view at any one time as the view pans and zooms throughout a scene.

At act 1618, the process 1600 ends.

Accordingly, the process 1600 may be executed to identify one or more background objects and generate a static image of the background. By identifying a static image of the background, the background may be rendered only once for a scene. As a view of the scene changes, such as by panning and zooming, a portion of the static image of the background shown in the view may be changed rather than re-rendering the background again.

As discussed above with respect to act 224, information for each analyzed scene may be compiled and encoded in a storage format indicated by a codec, such as the first codec 106. An example of a storage file format is provided below with respect to FIG. 17.

FIG. 17 illustrates a block diagram of features of a storage format 1700 according to an example. The storage format 1700 includes several features, including a metadata feature 1702, an objects feature 1704, an actions feature 1706, a directory feature 1708, a timeline feature 1710, a frames feature 1712, an events feature 1714, an optional segments feature 1716, and an optional versioning feature 1718, each of the features being indicative of files generated pursuant to the storage format 1700 for video media content.

The metadata feature 1702 includes assigning metadata to video media content in a corresponding file. For example, a file generated pursuant to the storage format 1700 may include metadata such as a name of the video media content, a length of the video media content, an author of the video media content, and any other desired metadata.

The objects feature 1704 includes representing elements displayed in the video media content as objects. All objects may be specified in a standardized manner in terms of the object class to which the object belongs, input data necessary to instantiate the object, a unique identifier for each object, and timeline information indicative of when the object is active in the video media content. For example, elements may be divided into classes including shapes, text, image, sounds, video, and so forth.

Shapes may include any element supported by SVG including lines, polygons, curves, and paths, each stored as raw SVG files. Text may include text boxes with inputs relating to the underlying text, including positioning, font, and styling. A URL to a font file may be absolute or relative. Images may include image files referenced with an absolute or relative URL. Audio may include audio tracks referred with an absolute or relative URL, and quality information (for example, expressed in bitrates, codecs, and so forth) if multiple alternative tracks are provided. Video may include an audio track referenced with an absolute or relative URL to one or more video files, and/or streaming manifests (for example, DASH and/or HLS).

To instantiate an object, and thereby provide information needed to load or render the object, a standard format may be used to represent the object. The standard format may indicate a unique object identifier, an object type, and object parameters, for each object. For example, if the object type is the “text” class, then the object parameters may include any parameters necessary to properly render a desired text box.

The actions feature 1706 includes supporting, for each object, one or more different actions. The actions may include, for example, animations, transformations, translations, morphing, attribute setting, media control, and so forth. More particularly, animations may include changing any SVG attribute gradually over time. Transformations may include scales, rotations, skews, and so forth. Translations may include movement of an object over a pre-defined path. Morphing may include changing the morphology of one shape to another. An attribute setting may include setting any basic SVG attribute (for example, opacity) on any element. Media control may include controlling media events (for example, playing media, pausing media, and so forth) for media elements (for example, audio and/or video elements).

To specify an action, a standard format may be used to represent the action. For example, the action may be represented by an action identifier, a corresponding object identifier, an action type, action parameters, and timing information. For example, if the action type is an “attribute setting” action, then the action parameters may include parameters indicating a desired parameter setting, such as object opacity, to which to set an object corresponding to the object identifier.

The directory feature 1708 includes an object model directory storing information about all objects stored by the file. For example, objects may be indexed by the objects' unique identifiers, the objects' relative placement, the objects' location, and so forth.

The timeline feature 1710 includes a standard timeline controlled by a single clock, relative to which actions are defined. That is, objects and actions may be synchronized to a single clock such that objects and actions are displayed and performed properly relative to one another. The clock to which the timeline is synchronized may or may not be synchronized to an actual time of day.

The frames feature 1712 includes rendering “frames” at any arbitrary point in time in video media content. Whereas raster-graphics video content may have individual frames, vector-graphics content may not include individual frames by default. Accordingly, the frames feature 1712 enables still images, conceptually similar to frames, to be rendered by determining a current state of a display of video media content at a certain time in the video media content.

The events feature 1714 includes user interface events (for example, play, pause, seek, video end, and so forth) that may be broadcast to all objects. Objects may further define listeners to such events, such that the objects may respond to events as they occur. For example, where an object is a video, and an event is a pause command, the video may observe the event and consequently pause the content being displayed in the video.

The optional segments feature 1716 is an optional feature including breaking certain video media content into separate segments. For example, it may be infeasible to load video media content in its entirety where the video media content is particularly large. Accordingly, video media content may be divided into separate segments of vector data. Dividing the video media content into separate segments may be beneficial in, for example, enabling streaming of the video media content. Each segment can include groups of objects and actions occurring in the corresponding segment. Each segment may be individually loaded such that an initial load time as video media content is first played is reduced, where only a first segment representing a subset of the video media content must be initially loaded.

A structure of the storage format 1700 may include a web-first format, such as DASH or HLS, in which an entry point to a video is a manifest file hosted at a web endpoint. The manifest file may contain metadata fields (for example, a name, duration, and so forth) and a list of segments, each including a segment start time and end time, a location of the segment file, and a file size of the segment file. Each segment may be a .zip file including a monolithic segment.json file which, in turn, includes a list of objects in the segment and a list of actions in the segment. Certain objects (for example, images, video, audio, and so forth) may require references to external files. The external files may be referenced via http URLs (for example, using absolute or relative URLs).

In other examples, the optional segments feature 1716 may not be included in the storage format 1700. For example, rather than segmenting video media content into separate segments, the video media content may be represented in full by a monolithic file (for example, a JSON file) including a list of all objects in the video media content and a list of all actions in the video media content. The monolithic file may be subsequently compiled into a binary representation for additional compression and packaged for storage (for example, packaged into an MPEG container as an MP4 file).

The optional versioning feature 1718 includes inputting, in a file, multiple versions of video media content. As discussed above, video media content may be converted to a vector-graphics format for storage in a file. The optional versioning feature 1718 may enable additional, different versions of the video media content to be included in the file. For example, the video media content may be stored in the file in a raster-graphics format with one or more qualities (for example, a 1080p version, a 720p version, a 480p version, and so forth) in addition to the vector-graphics format. A user and/or computing device accessing the file may thereby freely select a version of the video media content for playback from the versions included in the file. For example, if a computing device does not have a codec capable of playing the file in the vector-graphics format, the computing device may play the file in the raster-graphics format in one of the available qualities.

Accordingly, examples have been provided in which raster-graphics-formatted video media content may be converted into a vector-graphics-formatted video and stored pursuant to a storage format. For example, the first controller 110 may convert a raster-graphics-formatted video into a vector-graphics-formatted video and store the converted vector-graphics video in a storage format pursuant to the first codec 106 to yield a vectorized file. The vectorized file may subsequently be sent to the second computing device 104, whereby the second controller 118 may decode the vectorized file pursuant to the second codec 114 for playback to a user. Accordingly, examples provided herein enable a reduction in file sizes and, consequently, increased information transfer speeds.

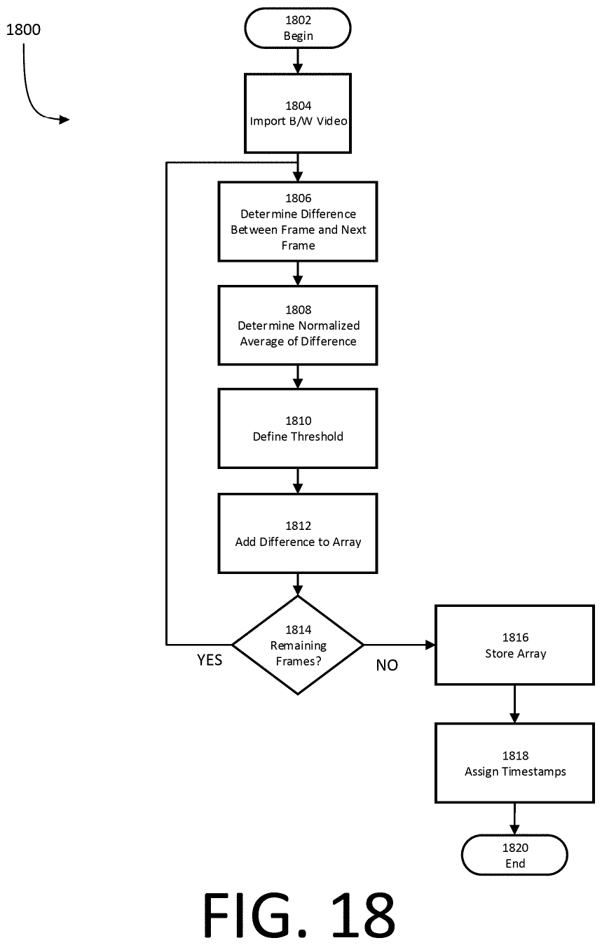

In various examples, additional, fewer, or different acts may be executed depending on a type of content being converted. For example, converting media content including presentation slide content (that is, video media content in which certain parts of the video media content include static presentation slides and further include, in some examples, moving video portions) to a vector-graphics format may include different acts. More particularly, converting media content including presentation slide content may include identifying static portions (that is, static slides) of the media content, extracting static images corresponding to the static portions, and extracting moving video portions of the media content, as discussed in greater detail with respect to FIG. 18.

FIG. 18 illustrates a process 1800 of converting media content including presentation slides to a vector-graphics format according to an example. The process 1800 may be executed by a controller, such as the first controller 110, executing a codec, such as the first codec 106, to convert video media content including presentation slides from a raster-graphics format to a vector-graphics format.

At act 1802, the process 1800 begins.

At act 1804, a video including at least one presentation slide is imported. In various examples, the video may be imported in a black-and-white colorspace. For example, the video may be imported in the black-and-white colorspace using OpenCV.

At act 1806, a determination is made as to a difference between a selected frame and a successive frame. For example, at a first execution of act 1806, the selected frame may be a first frame in the video and the successive frame may be a second frame in the video. Determining the difference between the frames may include calculating a difference in pixel values for each frame, whereby each of the frames and a resulting difference matrix each include the same dimensions (that is, having a height and width equal to the height and width of the frames expressed in numbers of pixels).

At act 1808, a normalized average of the difference between the frames is determined. For example, act 1808 may include executing a normalized average process on the difference matrix to yield a single scalar number indicative of the difference between the successive frames, such that the similarity or difference between the successive frames may be easily quantified. In various examples, larger normalized average values correspond to frames having more significant differences, and smaller normalized average values correspond to frames having fewer differences.

At act 1810, a threshold is defined. The threshold indicates a value for which normalized averages exceeding the threshold are considered to correspond to a change between the two successive frames from which the normalized average is derived. Conversely, normalized averages falling below the threshold are considered to correspond to situations in which there is no change between the successive frames.

At act 1812, the normalized average of the difference between the frames is added to a difference array. The difference array may include normalized averages of the difference between each pair of successive frames for which the normalized averages has been determined, ordered by the pairs' order of appearance in a scene.

At act 1814, a determination is made as to whether any frames remain to be analyzed. In various examples, each pair of successive frames is analyzed to determine a difference between each successive pair of frames. If frames remain to be analyzed (1814 YES), then the process 1800 returns to act 1806. Acts 1806-1814 are repeated until no frames remain to be analyzed. Responsive to determining that no frames remain to be analyzed (that is, that a difference has been determined between each successive pair of frames) (1814 NO), the process 1800 continues to act 1816.

At act 1816, the difference array discussed above with respect to act 1812 is stored. For example, where the process 1800 is executed in connection with the first controller 110, as discussed above, act 1816 may include storing the difference array in the first storage 108. Accordingly, in various examples, acts 1806-1814 include generating a difference array indicative of changes throughout an analyzed video, which stored at act 1816.

Array elements having a value of zero correspond to frames for which no significant change occurred from an immediately preceding frame. Conversely, elements having a non-zero value correspond to frames for which an appreciable change occurred from an immediately preceding frame. The threshold above which a change is considered significant may be controlled by modulating the threshold defined at act 1810. In various examples, the threshold may be selected such that values falling below the threshold correspond to static frames, and values exceeding the threshold correspond to non-static frames.

At act 1818, timestamps are assigned to transitions between static frames and non-static frames. The static frames may correspond to portions of the video content including static slides, and the non-static frames may correspond to portions of the video including moving videos. Accordingly, timestamps may be assigned to the transitions such that the video may be parsed into portions including static presentation slides, and portions including moving video. Each portion may be thereafter stored in connection with video segment objects, having information indicative of a type of the object (for example, an image for static image portions or video for moving video portions), a starting timestamp, and an ending timestamp.

At act 1820, the process 1800 ends.

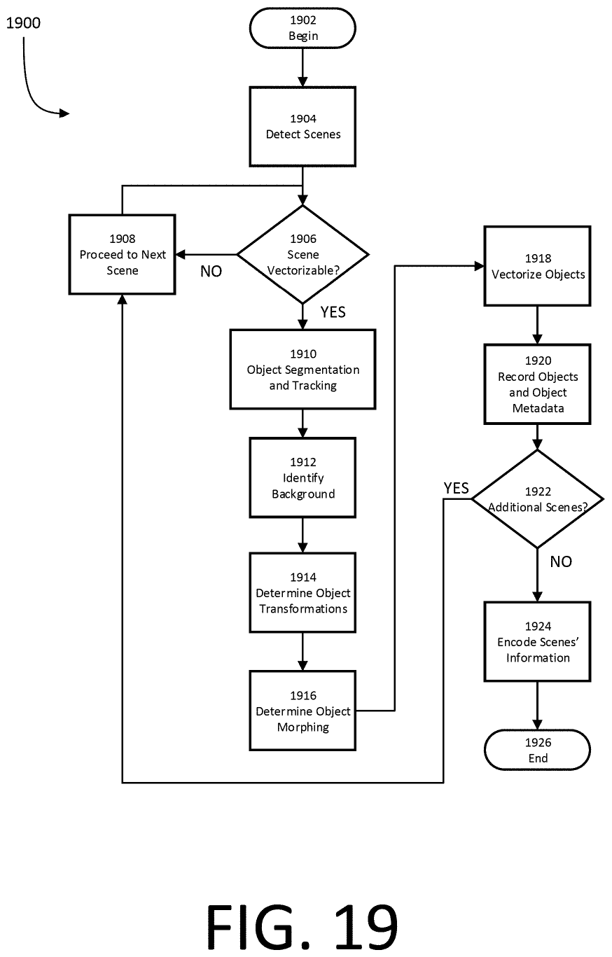

In some examples, alternate, additional, or fewer acts than those identified above may be performed in executing certain processes. For example, alternate processes may be executed (for example, by the first computing device 102 or the second computing device 104) to identify, track, and vectorize one or more objects in a scene in executing processes similar to the process 200. Although certain acts may be similar to acts of the process 200, other acts may differ from those of the process 200. An example is provided with respect to FIG. 19.

FIG. 19 illustrates a process 1900 of converting at least a portion of media content from a first format (for example, a raster-graphics format) to a second format (for example, a vector-graphics format) according to an example. The process 1900 may be executed by a controller, such as the first controller 110, executing a codec, such as the first codec 106, to convert at least a portion of video media content from a raster-graphics format to a vector-graphics format. For example, the process 1900 may be executed responsive to, or otherwise subsequent to, receiving input video media content including a plurality of frames from an upload source. The process 1900 may be executed in addition to or in lieu of the process 200 in certain examples.

At act 1902, the process 1900 begins.

At act 1904, scenes are detected. As discussed above, a scene may refer to a sequence of continuous, thematically related acts or interactions in a video. Act 1904 may therefore include detecting and parsing out these different scenes. Act 1904 may be substantially similar or identical to act 204, discussed above.

At act 1906, a determination is made as to whether each scene is vectorizable. For example, executing act 1906 for a first time may include determining whether a first scene of the scenes detected at act 1904 is vectorizable. As discussed above, being “vectorizable” refers to the comparative advantage of converting a unit of content to a vector-graphics format. Act 1906 may be substantially similar or identical to act 206, discussed above.

If a scene is not vectorizable (1906 NO), then the process 1900 continues to act 1908. At act 1908, a scene under consideration is incremented to a subsequent scene, and the process 1900 returns to act 1906 to consider the vectorizability of the subsequent scene. For example, if a first scene in the video media content is not vectorizable, then the process 1900 may proceed to execute a determination as to whether a second, subsequent scene in the video media content is vectorizable, and so forth, until a vectorizable scene is identified. Non-vectorizable scenes may be encoded in accordance with an alternate format, such as h264 encoding. If a vectorizable scene is identified (1906 YES), then the process 1900 continues to act 1910.

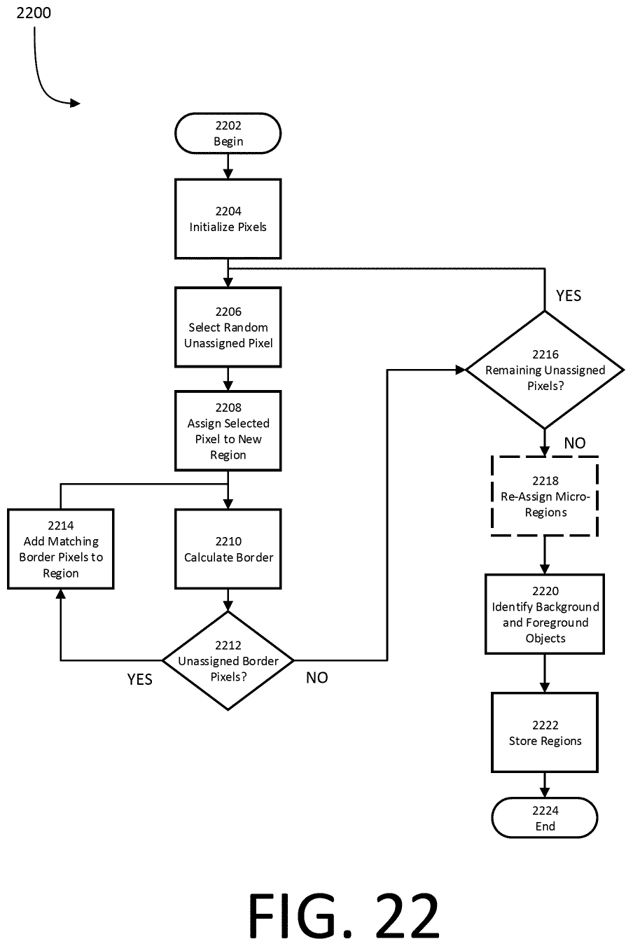

At act 1910, objects are segmented and tracked throughout a scene. In some examples, objects may be detected in each individual frame of a scene, and operations may subsequently be executed to match objects across frames and track the objects' movements across the individual frames. In other examples, however, objects may be segmented and tracked across an entire scene initially, rather than segmenting objects across a group of frames and subsequently matching and tracking objects across the frames through the scene. An example of act 1910 is provided below with respect to FIG. 22.

At act 1912, a background is identified. A background may generally include portions of a scene that are behind other objects in a scene for a substantial portion of the scene, such as a wall behind two characters conversing. As discussed above, detecting a background may advantageously enable the entirety of a background being displayed throughout a scene to be determined in advance and, as a scene progresses, different portions of the entirety of the background may be shown as a camera pans, zooms, moves, and so forth. In some examples, because act 1910 includes segmenting and tracking objects throughout a scene, act 1912 may include identifying objects that do not move significantly as the objects are tracked throughout a scene. For example, if an object does not move significantly, then the object may be determined to be a background object. In various examples, act 1912 may be substantially similar or identical to act 218, discussed above.

At act 1914, a determination is made as to how each object in a scene transforms throughout the scene. In some examples, act 1912 may include distinguishing between background and foreground objects, and act 1914 may include determining how each foreground object translates, rotates, and/or scales throughout a scene by determining a transformation matrix between each successive pair of frames. In some examples, act 1912, above, includes identifying background and foreground objects such that act 1914 need only include determining how each foreground object translates, rotates, and/or scales throughout a scene by determining a transformation matrix between each successive pair of frames. In various examples, act 1914 may include executing a RANSAC algorithm to match points on each object between successive frames. In various examples, only a transformation of foreground objects may be determined, as a background object is assumed to be relatively static, although in other examples a transformation of every object is determined at act 1914.

At act 1916, a determination is made as to how objects morph throughout a scene. Whereas transformation may include an object translating, rotating, and/or scaling such that an object is viewed in a different aspect, morphing may include changing a shape of the object itself. In various examples, act 1916 may be substantially similar or identical to act 220, discussed above.

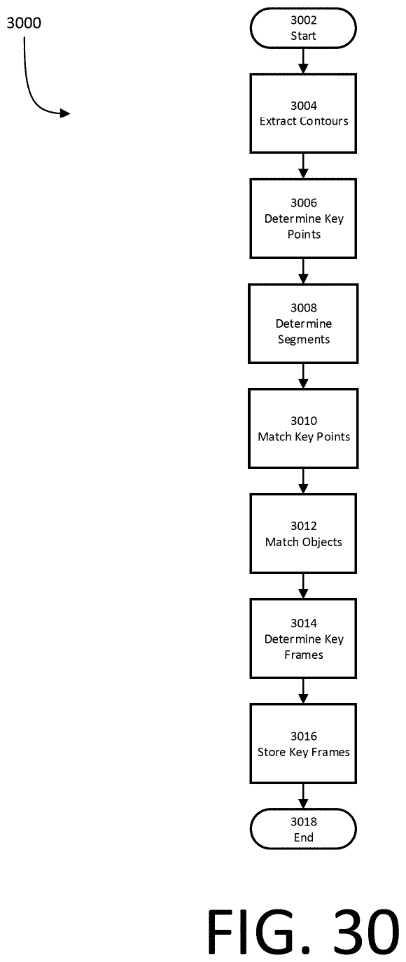

At act 1918, objects are vectorized. As discussed above, “vectorizing” refers to transforming an object from a first format (for example, a raster-graphics format) to a vector-graphics format. For example, vectorizing an object may include executing a Potrace algorithm to convert an object, such as an object indicated by a bitmap image, into a sequence of Bézier curves. In other examples, vectorization may include alternate examples, as discussed below with respect to FIG. 30.

At act 1920, objects and object metadata descriptive of the objects for a scene under consideration are recorded. More particularly, each object identified in a scene is recorded, and object metadata, such as information indicative of transformations and morphing that the object undergoes throughout the scene, are recorded in storage. The stored objects and object metadata may therefore represent each scene by individually representing each element (that is, object) throughout the scene.

At act 1922, a determination is made as to whether additional scenes remain to analyze. If there are additional scenes to analyze (1922 YES), then the process 1900 continues to act 1908. At act 1908, a scene under consideration is incremented to a subsequent scene. The process 1900 then returns to act 1906 to consider the vectorizability of the subsequent scene. The process 1900 continues until a determination is made that there are no additional scenes to be analyzed (1922 NO), at which point the process 1900 continues to act 1924.

At act 1924, objects and object metadata (collectively, “scene information”) for each scene are encoded. Encoding the scene information from each scene may include compiling the objects and object metadata into a vector video file. For example, the vector video file may include a zip file containing JSON text data, object metadata, vector data descriptive of each object, and so forth. Encoding the scene information may further include executing one or more optimization operations to further optimize storage and/or encoding of the scene information, as discussed in greater detail below. In various examples, encoding may be performed as a part of vectorization. For example, act 1918 may include the process 3000 of FIG. 30, which may include encoding vectorized objects.

At act 1926, the process 1900 ends.

As discussed above, act 1910 includes segmenting and tracking objects throughout a scene. Act 210 of the process 200, and the process 700, discussed above, enable objects in a frame to be segmented based on parameters of each pixel in a frame, such as pixel color. For example, a region-growing operation may be executed to grow regions of adjacent, similar-color pixels, and each region may be subsequently labeled as a separate, segmented object. However, because each frame is individually analyzed to segment objects on a frame-by-frame basis, a subsequent operation may need to be performed to match and track an object throughout a series of frames. In some examples, by contrast, act 1910 may include a process of segmenting and tracking objects on a scene-by-scene basis.

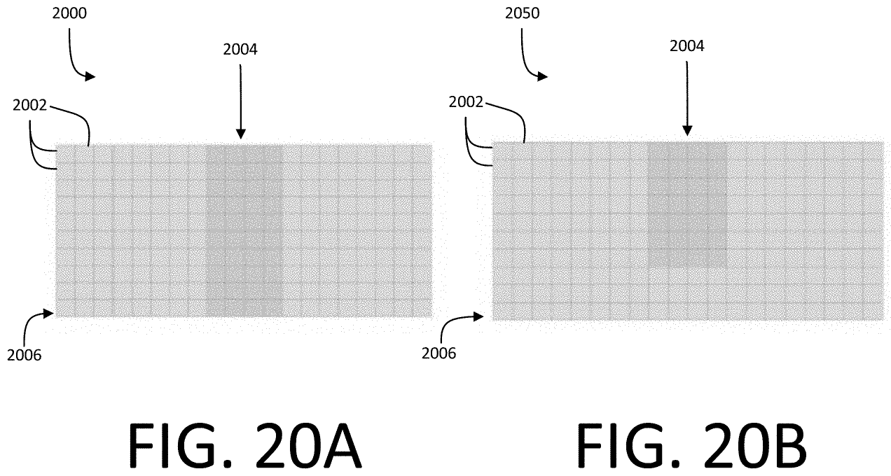

To illustrate the foregoing, FIG. 20A illustrates a front view of a first frame 2000 of a scene, and FIG. 20B illustrates a front view of a second frame 2050 of the scene. The frames 2000, 2050 may be two consecutive frames in the scene. Each of the frames 2000, 2050 includes an array of pixels 2002, and each of the frames 2000, 2050 illustrates an object 2004, indicated by a darker-gray color, in front of a background 2006, indicated by a lighter-gray color. As indicated by FIGS. 20A and 20B, less of the object 2004, and more of the background 2006, is visible in the second frame 2050 than in the first frame 2000 because the object 2004 is moving out of the scene from the first frame 2000 to the second frame 2050.

Segmenting the object 2004 on a frame-by-frame basis may include executing the process 700 on each of the frames 2000, 2050 individually, independent of the other frame. After segmenting the object 2004 in each of the frames 2000, 2050, a second, subsequent process or act (for example, act 216) may need to be executed to match the object 2004 from the first frame 2000 to the second frame 2050 and track the object 2004 if the frames 2000, 2050 are segmented on an object-by-object basis. Alternatively, if objects are segmented on a scene-by-scene basis, then object segmentation may inherently provide object matching and tracking.

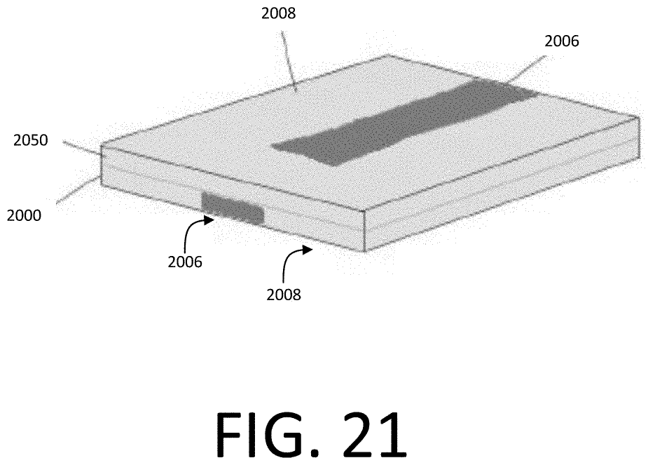

Segmenting objects on a scene-by-scene basis may be conceptualized by considering a scene as a three-dimensional matrix of pixels, where two dimensions represent a horizontal and vertical dimension of an array of pixels in a frame, and a third dimension represents time. That is, the three-dimensional matrix may represent a series of two-dimensional frame matrices “stacked” on top of one another, where the “height” of the stack corresponds to time. For example, the first frame 2000 and the second frame 2050 may each individually include the two-dimensional array of pixels 2002 having a height and a width. If the frames 2000, 2050 are stacked on top of one another, as indicated by FIG. 21, then a series of frames may be represented as a three-dimensional matrix of pixels. An entire scene may thus be represented by a three-dimensional matrix of pixels, where each “slice” of the matrix is an individual frame in the scene and a height of the matrix represents the duration of the scene. Object segmentation and tracking may subsequently be performed in connection with a three-dimensional “scene matrix” rather than a two-dimensional “frame matrix.”

FIG. 22 illustrates a process 2200 of segmenting and tracking objects in a scene according to an example. The process 2200 may be executed with respect to each scene in a series of one or more scenes. As discussed in greater detail below, the process 2200 includes gradually assigning each pixel in a scene to a region, where each resulting region will be identified as a separate object. The process 2200 is substantially similar to the process 700, except that the process 2200 may be executed in connection with a three-dimensional scene matrix whereas the process 700 may be executed in connection with a two-dimensional frame matrix.

At act 2202, the process 2200 begins.

At act 2204, pixels in a three-dimensional scene matrix are initialized. Initializing the pixels may include marking each pixel in the scene as not corresponding to any region.

At act 2206, a random pixel not assigned to any region is selected. Where act 2206 is first executed after executing act 2204, a random pixel may be selected from all of the pixels in the scene, because all of the pixels in the scene are indicated as not being assigned to any region. In some examples, act 2206 may include identifying a random pixel not assigned to any region from a first frame in a scene, or otherwise from an earliest frame having pixels not assigned to any region. In other examples, any random pixel is selected.

At act 2208, the selected pixel is assigned to a new region. For example, where act 2208 is first executed, a new region (for example, a “First Region”) may be generated, and may be defined as including the selected pixel. In another example, where act 2208 is executed a second time, a new region (for example, a “Second Region”) distinct from the First Region may be generated, and may be defined as including the selected pixel, and so forth for each subsequent execution of act 2208.

At act 2210, a border of the region to which the selected pixel is assigned is determined. The border of the region to which the selected pixel is assigned includes any pixels that are outside of the assigned region, and which are separated by a threshold number of pixels, such as a threshold of one pixel, in a horizontal, vertical, depth, or diagonal direction from any pixel in the assigned region. That is, the border includes any pixels that are adjacent to pixels in the assigned region by the threshold number of pixels, and which are not themselves already in the assigned region. For example, where the assigned region includes only one pixel (that is, the selected pixel), the threshold number of pixels is one, and the one pixel is part of a frame that is sandwiched between two other frames in the three-dimensional matrix (unless, for example, the frame is a first or last frame in the scene), the border includes the 26 directly adjacent pixels, including two horizontal pixels to the left and right of the selected pixel within the same frame, two vertical pixels above and below the selected pixel within the same frame, two depth pixels in front of and behind the selected pixel in a preceding and successive frame, and 20 diagonal pixels at the eight vertices of the selected pixel and the 12 edges of the selected pixel in the same frame and the preceding and subsequent frame.

In examples in which the threshold number of pixels is greater than one, pixels that are not directly contacting the selected pixel may nonetheless be considered border pixels in subsequent acts. The threshold number of pixels may vary based on a dimension. For example, a first threshold may exist in a horizontal and vertical dimension, and a second threshold may exist in a depth direction. That is, a first definition may exist for border pixels in the same frame—for example, only directly adjacent pixels may be considered border pixels in a single frame—but a second definition may exist for border pixels across different (that is, preceding or successive) frames. For example, the threshold may be greater for border pixels across different frames such that even if an object is not “overlapping” in a scene across two successive frames, the object may be recognized as a single object rather than two separate objects.

At act 2212, a determination is made as to whether any pixels bordering the region to which the selected pixel is assigned (also referred to as “border pixels”) have yet to be assigned to a region. If there are border pixels that have not yet been assigned to a region (2212 YES), then the process 2200 continues to act 2214. For example, where act 2212 is first executed, none of the border pixels may be assigned to a region, because only the selected pixel is assigned to a region.

At act 2214, border pixels that match the region to which the selected pixel is assigned are added to the region. A match may be identified where a border pixel has a similar color as the region or the selected pixel. For example, a match may be identified where a weighted distance between a color of the border pixel and a color of the region or the selected pixel is within a specified value (for example, 15) on a scale of color values (for example, ranging from 0 to 255). That is, in one example, a match may be found between a selected pixel or region having a color value of 100 and any border pixel having a color value between 85 and 115. In various examples, the weighted distance between the color of the border pixel and the color of the region may be determined in the YUV colorspace, and a four-times emphasis may be placed on the Y-channel. In some examples, a color of a region may be defined based on the pixels in the region, such as by being an average color of the pixels in the region.

Once matching border pixels have been added to the region, the process 2200 continues to act 2210, at which point a border is re-calculated. The border may expand where additional pixels have been added to the region. In some examples, however, the border may not expand even where additional pixels have been added to the region. For example, the border may not expand where any newly added pixels do not border any unassigned pixels that were not already border pixels prior to adjusting the region at act 2214. Accordingly, determining the border at act 2210 may or may not yield an updated border.

Returning to act 2212, if there are no unassigned border pixels (2212 NO), then the process 2200 continues to act 2216. In various examples, act 2212 may implement hysteresis. For example, if an unassigned border pixel is determined not to match a region at act 2214, then a subsequent execution of act 2212 may ignore the previously analyzed unassigned border pixel because the unassigned border pixel has already been determined to not match a color of the region.

At act 2216, a determination is made as to whether any unassigned pixels (that is, pixels not assigned to a region) remain in the scene. If any unassigned pixels remain in the scene (2216 YES), then the process 2200 returns to act 2206. Acts 2206-2216 may be repeatedly executed until every pixel in the scene is assigned to a region. If every pixel has been assigned to a region (2216 NO), then the process 2200 may continue to optional act 2218, or may continue to act 2220 where act 2218 is not executed.

At optional act 2218, pixels in micro-regions may be re-assigned to other regions. As discussed above, a micro-region refers to a region including a number of pixels that is below a threshold value. Micro-regions may be re-assigned to a neighboring region that is not a micro-region, such as a neighboring region having a closest weighted color value to the micro-region. Eliminating micro-regions may be advantageous to avoid identifying groups of pixels that are too small to be properly identified as separate regions, and that should be included in neighboring regions. In other examples of the process 2200, optional act 2218 is not executed, and micro-regions are not altered.

At act 2220, objects determined above are identified as either foreground or background objects. As discussed above, a background may include one or more objects that are depicted as being behind other objects in a foreground of a scene for a substantial proportion of the scene. In many examples, background objects may be relatively static and do not undergo substantial transformations or morphing throughout a scene. Accordingly, identifying background objects may include determining how much an object changes throughout a scene. If the object changes relatively little (for example, below a threshold amount), then the object may be identified as a background object. Conversely, if the object changes relatively significantly throughout the scene (for example, above a threshold amount), then the object may be identified as a foreground object. Accordingly, in some examples, objects may be identified as either a background or a foreground object.

In one example, determining a change of an object throughout a scene includes subtracting an object in one frame from the object in an immediately preceding frame. For example, subtracting the object across two successive frames may include determining a pixel-wise difference of pixel values (for example, color values). This operation may be performed for each object in each pair of successive frames throughout a scene. If the pixel-wise difference exceeds a threshold, then the object may be determined to be changing significantly enough to be a foreground object. For example, applying the threshold may include determining whether a change in a value of any single pixel across a pair of frames exceeds a threshold value. In another example, applying the threshold may include determining whether a change in a value of any single pixel across an entire scene exceeds a threshold value. In still other examples, applying the threshold may include considering a change of two or more pixels, such as determining whether a sum of the differences of the pixels across two or more frames (including, for example, an entire scene) exceeds a threshold value.

At act 2222, regions are stored. For example, where optional act 2218 is executed, act 2222 may include storing every region remaining after execution of act 2218. In examples in which optional act 2218 is not executed, act 2220 may include storing every region identified after every pixel has been assigned to a region (2216 NO). Storing the regions may include storing an indication of whether each object corresponding to a respective region is a foreground object or a background object.

At act 2224, the process 2200 ends. In examples in which the process 2200 is an example of act 1910 of the process 1900, the process 1900 may continue to act 1914 to determine transformations of the foreground objects, and so forth.

As discussed above, certain processes involve encoding and/or compiling vectorized media content into a file for storage (for example, including act 1924 of the process 1900). One or more optimization operations may be executed to optimize storage of the media content. Optimizations may include reducing a size of a file, for example, or otherwise making the file easier to read and/or render.

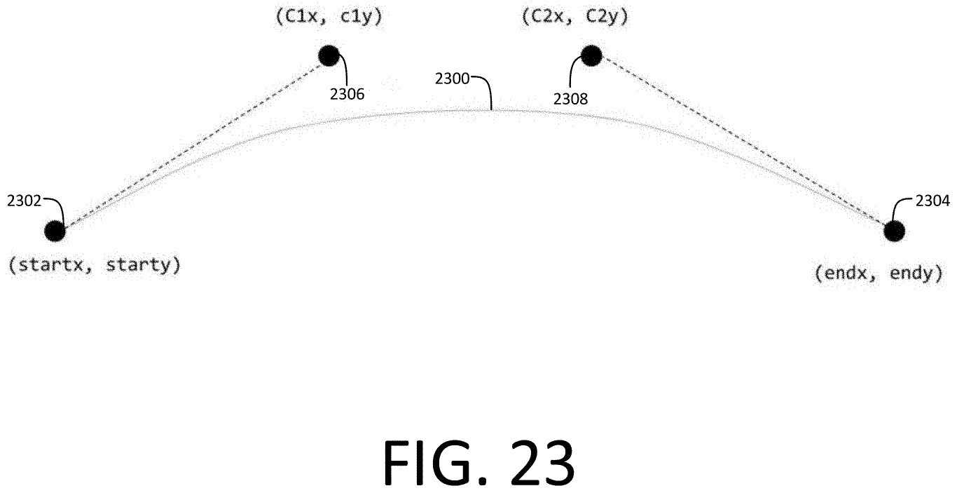

Vectorized media may be represented by a series of Bézier curves, as discussed above. A Bézier curve may be represented by one or more values, or control points, which enable a Bézier curve to be represented and/or recreated by a computer. For example, FIG. 23 illustrates a schematic view of a Bézier curve 2300 beginning at a starting point 2302 and terminating at an ending point 2304. A curvature of the Bézier curve 2300 may be defined with reference to a first control point 2306 and a second control point 2308. The Bézier curve 2300 may be defined by initially being tangent to a line connecting the starting point 2302 and the first control point 2306 and terminating by being tangent to a line connecting the ending point 2304 and the second control point 2308. A curvature of the Bézier curve 2300 may depend on a distance between the starting point 2302 and the first control point 2306 and/or a distance between the ending point 2304 and the second control point 2308. The Bézier curve 2300 may thus be capable of being represented and/or recreated by an entity, such as a computer, having knowledge of the four points 2302-2308.

In some examples, the points 2302-2308 may be represented by a pair of coordinates. The points 2302-2308 may be represented by a pair of coordinates in an x-y coordinate system in some examples. If the starting point 2302 is assumed to be at an origin (0,0) of the coordinate system and thus need not be transmitted to represent the Bézier curve 2300, then a total of six coordinates—that is, a pair of x, y values for each of the other three points 2304-2308—may be used to represent the Bézier curve 2300.

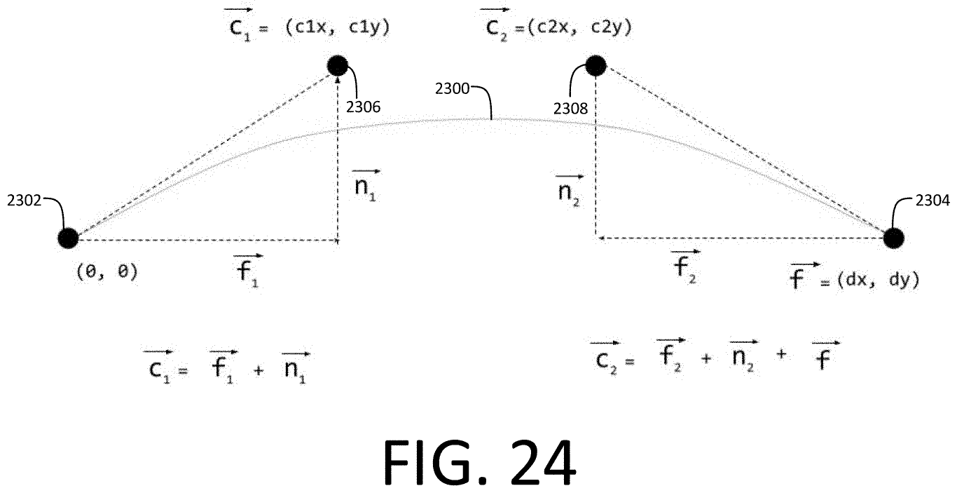

In other examples, a different coordinate system may be implemented, such as an f-n coordinate system. In the f-n coordinate system, the f-axis is defined as a line connecting the starting point 2302 and the ending point 2304, and the n-axis is defined as a line perpendicular to the f-axis, with an origin (0,0) at the starting point 2302. As illustrated in FIG. 24, each of the points 2302-2308 may be represented as a pair off, n coordinates, with the assumption that the starting point 2302 is at an origin (0,0).

Although curve information indicating the f, n coordinates of each individual one of the points 2302-2308 enables the Bézier curve 2300 to be generated by a recipient of the curve information, the curve information may include redundant information. That is, it may be possible to represent the Bézier curve 2300 with less information than the f, n coordinates of each one of the points 2302-2308. For example, as discussed above, the coordinates of the starting point 2302 may assumed to be at the origin (0,0) and are therefore not necessary to generate the Bézier curve 2300. Furthermore, a position of the control points 2306, 2308 on the n-axis may always be equal to one another in certain examples, such as examples in which the Bézier curve 2300 is generated by a Potrace algorithm. That is, with reference to FIG. 24, n₁ may always be equal to n₂ such that it is redundant to include both n₁ and n₂ in curve information representing the Bézier curve 2300.

Accordingly, storing a representation of the Bézier curve 2300 may be accomplished by storing only the coordinates n, c_{1f}, c_{2f}, dx, dy, where n is the position of the control points 2306, 2308 along the n-axis, c_{1f} is a position of the first control point 2306 along the f-axis, c_{2f} is a position of the second control point 2308 along the f-axis, dx is a position of the ending point 2304 along the f-axis, and dy is a position of the ending point 2304 along the n-axis.

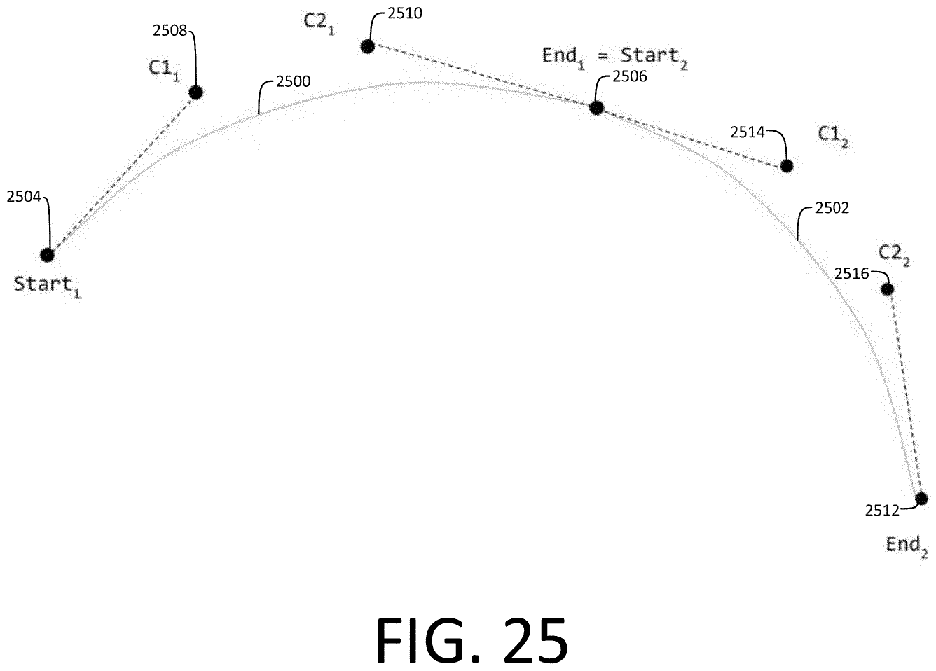

Additional redundancies may be eliminated where, for example, a shape is represented by consecutive Bézier curves, as illustrated in FIG. 25. FIG. 25 illustrates a first Bézier curve 2500 and a second Bézier curve 2502. The first Bézier curve 2500 includes a starting point 2504, an intermediate point 2506 nominally acting as a termination point, a first control point 2508, and a second control point 2510. The second Bézier curve 2502 includes the intermediate point 2506 nominally acting as a starting point, a termination point 2512, a third control point 2514, and a fourth control point 2516. The Bézier curves 2500, 2502 may be referred to as “consecutive” inasmuch as the intermediate point 2506 nominally acts as a termination point to the first Bézier curve 2500 and as a starting point to the second Bézier curve 2502 such that a continuous curve is formed by the Bézier curves 2500, 2502.

In some examples, such as examples in which a Potrace algorithm is executed to generate consecutive Bézier curves, an intermediate point of the consecutive Bézier curves may always lie on a line connecting a second control point of a first Bézier curve and a first control point of a second Bézier curve. For example, the intermediate point 2506 lies on a line connecting the second control point 2510 and the third control point 2514. Accordingly, if an n- and f-axis value of the second control point 2510 and an n-axis value of the second Bézier curve 2502 are known, then an f-axis value of the third control point 2514 may be determined. Representing consecutive Bézier curves (that is, Bézier curves having starting points that are termination points of other, preceding Bézier curves) may thus be accomplished with the coordinates n, c₂, dx, dy, where n is a position of the third and fourth control points 2514, 2516 along the n-axis position, c₂ is the position of the second control point 2510 along the f-axis and n-axis, dx is a position of the termination point 2512 along the f-axis, and dy is a position of the termination point 2512 along the n-axis. Accordingly, further optimizations may be achieved by eliminating additional redundancies in storing a representation of consecutive Bézier curves.

After vectorized media content is efficiently represented in the manner discussed above, a file representing the media content may be generated, as discussed in greater detail below, and subsequently rendered by a rendering engine to playback the media content to a user. Rendering may be performed in a manner that optimizes playback of the media content, such as by reducing buffering times. The media content may be represented by Bézier curves, as discussed above. As appreciated by one of ordinary skill in the art, a cubic Bézier curve is governed by the equation,

B(t)=(1−t)³P₁+3(1−t)²tP₂+3(1−t)t²P₃+t³P₄,0≤t≤1

where P₁-P₄ are control points and t is a unitless parameter indicating a position along a Bézier curve from a starting point (at P₁, where t=0) to an ending point (at P₄, where t=1). The Bézier curve is thus a summation of various control points multiplied by respective coefficients which vary based on a value of t as t varies from 0 to 1. If the coefficients are abbreviated as follows,

a=(1−t)³;b=341−t)²;c=3t²(1−t);d=t³

then a matrix of the coefficients may be expressed as,

$$T = [ \begin{matrix}{a}_{t = 0} & {b}_{t = 0} & {c}_{t = 0} & {d}_{t = 0} \\ {a}_{t = 0.1} & {b}_{t = 0.1} & {c}_{t = 0.1} & {d}_{t = 0.1} \\ {a}_{t = 0.2} & {b}_{t = 0.2} & {c}_{t = 0.2} & {d}_{t = 0.2} \\ {a}_{t = 0.3} & {b}_{t = 0.3} & {c}_{t = 0.3} & {d}_{t = 0.3} \\ … & … & … & …\end{matrix} ]$$

and the cubic Bézier curve may be expressed as,

$$[ \begin{matrix}{B}_{t = 0} \\ {B}_{t = 0. 1} \\ {B}_{t = 0.2} \\ {B}_{t = 0. 3} \\ {B}_{t = 0.4}\end{matrix} ] = T [ \begin{matrix}{P}_{1} \\ {P}_{2} \\ {P}_{3} \\ {P}_{4}\end{matrix} ]$$

Accordingly, because the matrix T is simply a matrix of constant values, hundreds of thousands of Bézier curves may be calculated in parallel simply by feeding the matrix T and the control points P₁-P₄ defining each Bézier curve into a processor. In some examples, processing the Bézier curves in this manner enables a graphics-processing unit (GPU) to simultaneously execute many of such calculations in parallel, drastically reducing rendering times. This “linear algebra technique” may be implemented to achieve various efficiencies discussed in greater detail below.

Additional efficiencies in rendering may be achieved by leveraging aspects of triangle fans, that is, a group of triangles sharing a common vertex. Media rendered in graphics libraries such as WebGL and OpenGL must generally be broken down into triangles in order to be rendered properly. If a triangle fan is generated to represent the polygon by having common edges with the polygon, then the portion of the triangle fan inside the polygon includes an odd number of triangles and the portion of the triangle fan outside of the polygon includes an even number of triangles.

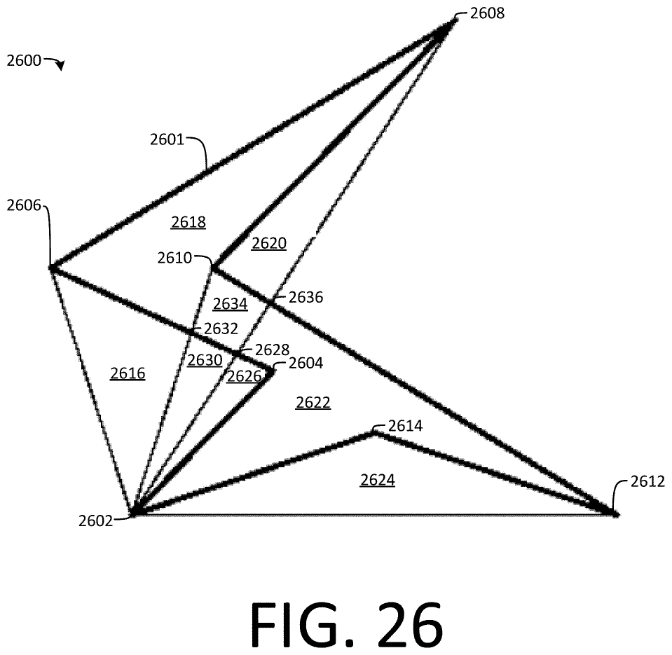

For example, FIG. 26 illustrates a diagram of a triangle fan 2600 representing a polygon 2601. The polygon 2601 includes a first vertex 2602, a second vertex 2604, a third vertex 2606, a fourth vertex 2608, a fifth vertex 2610, a sixth vertex 2612, and a seventh vertex 2614. The polygon 2601 includes edges connecting the first vertex 2602 and the second vertex 2604, the second vertex 2604 and the third vertex 2606, the third vertex 2606 and the fourth vertex 2608, the fourth vertex 2608 and the fifth vertex 2610, the fifth vertex 2610 and the sixth vertex 2612, the sixth vertex 2612 and the seventh vertex 2614, and the seventh vertex 2614 and the first vertex 2602.

The triangle fan 2600 includes triangles representing the polygon 2601 including a first triangle 2616 having vertices at the first vertex 2602, the second vertex 2604, and the third vertex 2606, a second triangle 2618 having vertices at the first vertex 2602, the third vertex 2606, and the fourth vertex 2608, a third triangle 2620 having vertices at the first vertex 2602, the fourth vertex 2608, and the fifth vertex 2610, a fourth triangle 2622 having vertices at the first vertex 2602, the fifth vertex 2610, and the sixth vertex 2612, and a fifth triangle 2624 having vertices at the first vertex 2602, the sixth vertex 2612, and the seventh vertex 2614.

Additional triangles may be formed having vertices where edges of the triangle fan 2600 meet edges of the polygon 2601. For example, a sixth triangle 2626 includes vertices at the first vertex 2602, the second vertex 2604, and an eighth vertex 2628, a seventh triangle 2630 includes vertices at the first vertex 2602, the eighth vertex 2628, and a ninth vertex 2632, and an eighth triangle 2634 includes vertices at the first vertex 2602, the fifth vertex 2610, and a tenth vertex 2636.

For any point within the triangle fan 2600 but outside of the polygon 2601, the point will fall within an even number of triangles of the eight triangles 2616, 2618, 2620, 2622, 2624, 2626, 2630, 2634 discussed above. For any point within both the triangle fan 2600 and the polygon 2601, the point will fall within an odd number of triangles of the eight triangles 2616, 2618, 2620, 2622, 2624, 2626, 2630, 2634 discussed above.

As a result, certain optimizations may be achieved by leveraging a triangle-fan feature and a stencil buffer feature, such as those available in WebGL or OpenGL, to draw any closed two-dimensional shape. More particularly, any arbitrary polygon or polygons representing an object may be drawn with a triangle fan using the triangle fan feature, and using the stencil buffer feature to set each pixel to a given identification number. Each time a triangle of the triangle fan 2600 is drawn, a stencil inversion feature may be executed to invert the identification numbers of the pixels falling within the drawn triangle. Because every pixel outside of the polygon 2601 but within the triangle fan 2600 is located within an even number of triangles, an even number of inversions will be applied to the outside pixels. Because an even number of inversions cancel one another out, an identification number for each outside pixel ultimately does not change after the inversions are carried out. Conversely, each pixel inside of the polygon 2601 is located within an odd number of triangles and is subjected to an odd number of inversions, such that the pixels inside of the polygon 2601 have a common identification number. Because the pixels within the polygon 2601 share a common identification number, this stencil test may be implemented to only draw triangles on pixels having an identification number equal to a certain value. An application of this feature is discussed in greater detail below.

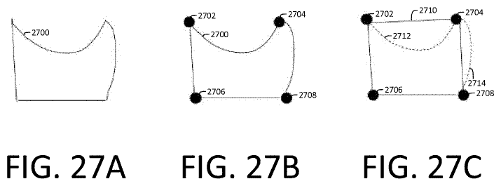

A shape may be represented as a series of one or more Bézier curves, as discussed above. For example, FIG. 27A illustrates a schematic diagram of a shape 2700. FIG. 27B illustrates a schematic diagram of the shape 2700 with a first control point 2702, a second control point 2704, a third control point 2706, and a fourth control point 2708 at the vertices of the shape 2700. As illustrated by FIG. 27B, the shape 2700 is composed of a first Bézier curve between the first control point 2702 and the second control point 2704, a second Bézier curve between the second control point 2704 and the fourth control point 2708, a first straight line between the third control point 2706 and the fourth control point 2708, and a second straight line between the third control point 2706 and the first control point 2702.

FIG. 27C illustrates a schematic diagram of a coarse polygon 2710 generated based on the control points 2702-2708 to represent the shape 2700, and further illustrates a first Bézier curve 2712 generated between the first control point 2702 and the second control point 2704 and a second Bézier curve 2714 generated between the second control point 2704 and the fourth control point 2708. The coarse polygon 2710 is a coarse representation of the shape 2700, and the Bézier curves 2712, 2714 are indicative of further refinement to more closely approximate features of the shape 2700.

As discussed above, the triangle-fan feature and the stencil-buffer feature may be used in combination to render any arbitrary polygon, such as the coarse polygon 2710. Furthermore, the linear algebra technique discussed above may be implemented to independently render Bézier curves, such as the first and second Bézier curves 2712, 2714. A technique for using the Bézier curves 2712, 2714 to further refine the coarse polygon 2710 to more closely approximate the shape 2700 will now be described.

A determination may need to be made as to whether each rendered Bézier curve is intended to remove portions of the coarse polygon 2710, or add portions to the coarse polygon 2710, when attempting to generate a polygon representing the shape 2700. For example, the first Bézier curve 2712 is intended to remove portions of the coarse polygon 2710 between the first Bézier curve 2712 and the border of the coarse polygon 2700 between the first control point 2702 and the second control point 2704. Conversely, the second Bézier curve 2714 is intended to add to the coarse polygon 2700 between the second Bézier curve 2714 and the border of the coarse polygon 2700 between the second control point 2704 and the fourth control point 2708.

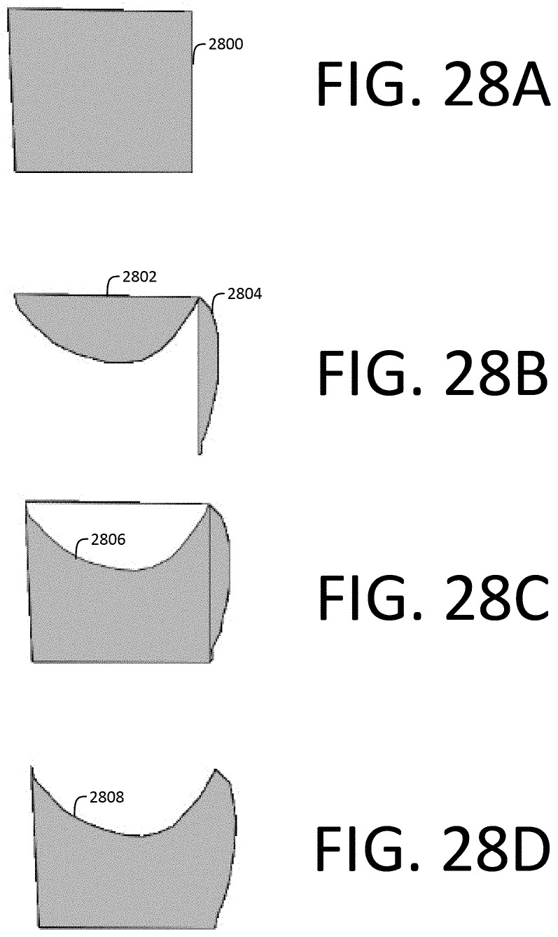

One example solution is to execute a bitwise XOR operation by which a polygon is rendered only where the coarse polygon 2700 or one of the Bézier curves 2712, 2714 are, but not both. For example, FIG. 28A illustrates a schematic view of a polygon 2800 generated based solely on the coarse polygon 2700. FIG. 28B illustrates a schematic view of a first Bézier curve region 2802 generated between the first Bézier curve 2712 and the border of the coarse polygon 2700 between the first control point 2702 and the second control point 2704, and a second Bézier curve region 2804 generated between the second Bézier curve 2714 and the border of the coarse polygon 2700 between the second control point 2704 and the fourth control point 2708.

FIG. 28C illustrates a schematic view of a modified polygon 2806 resulting from a bitwise XOR operation executed between the polygon 2800, the first Bézier curve region 2802, and the second Bézier curve region 2804. Because the polygon 2800 overlaps the first Bézier curve region 2802, the overlapping portion is removed. Conversely, because the polygon 2800 does not overlap the second Bézier curve region 2804, the second Bézier curve region 2804 is added to the polygon 2800. Any previously generated borders of the polygon 2800 that do not border the modified polygon 2806 on only one side may then be removed such that only exterior borders of the modified polygon 2806 remain. This may enable polygons to be rendered correctly even where a shape has a hole inside of the shape, such that a rendered polygon properly has both an exterior and interior border. In this example, the polygon may be described as being defined by contours rather than a single exterior border.

FIG. 28D illustrates a resultant polygon 2808 representing the result of removing extraneous borders from the modified polygon 2806, including the straight line connecting the first control point 2702 and the second control point 2704 and the straight line connecting the second control point 2704 and the fourth control point 2708.

Certain functions, such as stencil-buffering features, facilitate execution of the above-described bitwise XOR operations to generate any closed shape defined as a series of Bézier curves. However, while such functions may be effective for generating single, isolated shapes, the functions may not be as effective where multiple shapes in close proximity are rendered.

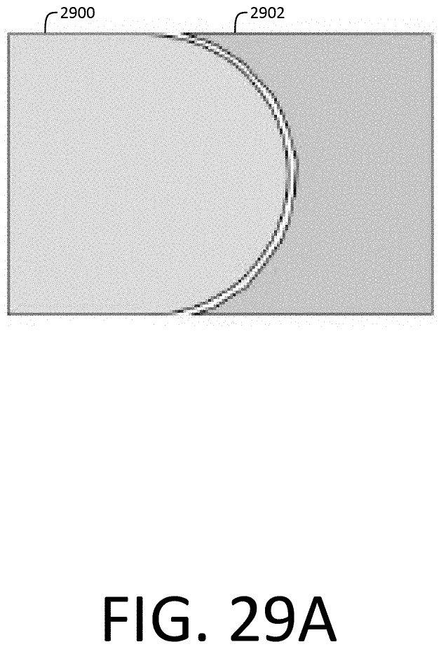

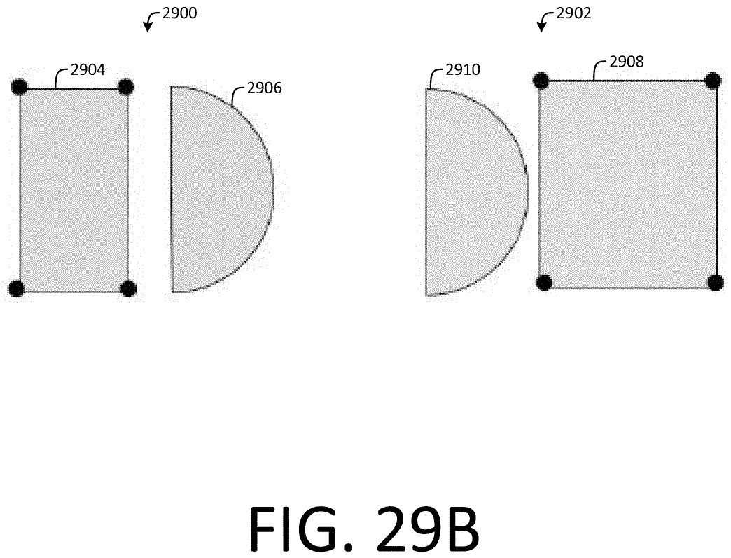

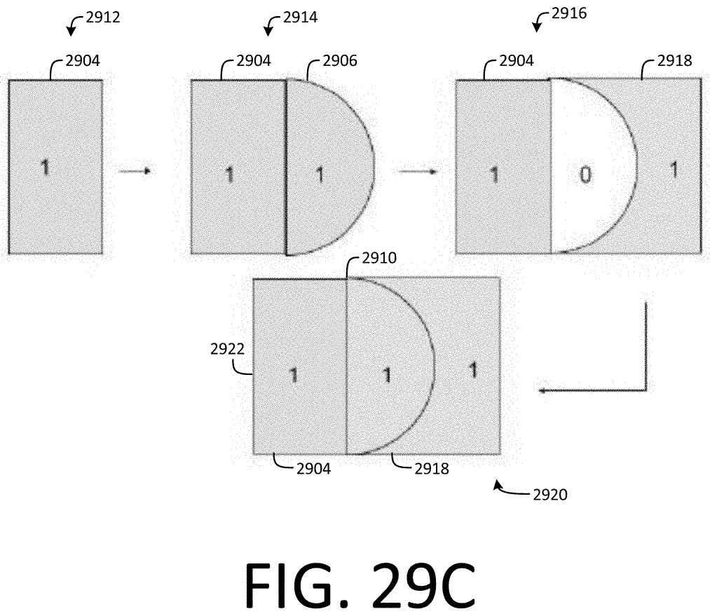

For example, FIG. 29A illustrates a schematic view of a first shape 2900 and a second shape 2902 near one another. FIG. 29B illustrates the first shape 2900 broken into a first coarse polygon 2904 and a first Bézier curve region 2906, and the second shape 2902 broken into a second coarse polygon 2908 and a second Bézier curve region 2910. Executing the bitwise XOR operation process discussed above with respect to FIGS. 28A-28D may yield errors.

For example, FIG. 29C illustrates a schematic flow diagram of executing the above-described bitwise XOR operations. At a first stage 2912, the first coarse polygon 2904 is added. No other shapes are yet present, so no bitwise XOR operation needs to be executed. At a second stage 2914, the first Bézier curve region 2906 is added, and a bitwise XOR operation is executed between the first coarse polygon 2904 and the first Bézier curve region 2906. Because the first coarse polygon 2904 and the first Bézier curve region 2906 do not overlap, the shapes are added together.

At a third stage 2916, the second coarse polygon 2908 is added and a bitwise XOR operation is executed between the first coarse polygon 2904, the first Bézier curve region 2906, and the second coarse polygon 2908. Because the first Bézier curve region 2906 and the second coarse polygon 2908 overlap, the portion of space occupied by the first Bézier curve region 2906 is removed to yield a modified second coarse polygon 2918. Finally, at the fourth stage 2920, the second Bézier curve region 2910 is added and a bitwise XOR operation is executed between the first coarse polygon 2904, the second Bézier curve region 2910, and the modified second coarse polygon 2918.

Because none of the shapes overlap at the fourth stage 2920, a resultant polygon 2922 is a single polygon. This may be considered erroneous at least because the original shapes 2900, 2902 were two separate shapes, not a single shape. Although FIG. 29C presents a specific order of adding shapes for purposes of example, it is to be appreciated that the resultant polygon 2922 may be generated regardless of what order the shapes are added in. Accordingly, errors may arise using the above-described features, particularly where the bitwise XOR operations are not executed to discriminate based on whether overlapping regions belong to the same shape or different shapes.

In another example, shapes are given unique identification numbers prior to executing the bitwise XOR operations. Furthermore, the bitwise XOR operations are only executed between portions of each shape. For example, a Bézier curve region of one shape, such as the first Bézier curve region 2906 of the first shape 2900, will have no effect on a coarse polygon of another shape, such as the second coarse polygon 2908 of the second shape 2902, even if they are overlapping, because the shapes 2900, 2902, and the constituent portions thereof, may have different identification numbers.

Consider an example in which pixels in regions that are not occupied by shapes have a default value of zero, and in which pixels in regions that are occupied by shapes have a value corresponding to an identification number of a shape. Each shape, and portions thereof, may be given a unique identification number prior to executing the bitwise XOR operation. This unique identification number may also be referred to as mask. Continuing with the example provided above in FIG. 29, it is desirable to render the shapes 2900, 2902, which may be difficult in a conflicting region where portions of the shapes 2900, 2902 may overlap, such as an example conflict region occupied by the first Bézier curve region 2906, the second coarse polygon 2908, and the second Bézier curve region 2910.

Suppose that the first shape 2900 is given a first identification number, 1, and that the second shape 2902 is given a second identification number, 2. Converting these values to 8-bit binary for purposes of example only, the first shape 2900 has an identification number of 00000001 and the second shape 2902 has an identification number of 00000010. Using these mask values, the bitwise XOR operations may be executed on a pixel in the conflicting region, where the pixel has a default value of 00000000 as discussed above. An example order of operations is provided, although a result may be identical regardless of an order of operations performed.

First, inversion is executed based on the second coarse polygon 2908. The second coarse polygon 2908 is part of the second shape 2902, and thus has an identification number of 00000010. A bitwise XOR operation between the value of the pixel, 00000000, and the identification number of the second coarse polygon 2908, 00000010, yields 00000010. The pixel value thus becomes 00000010.

Next, inversion is executed based on the first Bézier curve region 2906. The first Bézier curve region 2906 is part of the first shape 2900, and thus has an identification number of 00000001. A bitwise XOR operation between the value of the pixel, 00000010, and the identification number of the first Bézier curve region 2906, 00000001, yields 00000011. The pixel value thus becomes 00000011.

Finally, inversion is executed based on the second Bézier curve region 2910. The second Bézier curve region 2910 is part of the second shape 2902, and thus has an identification number of 00000010. A bitwise XOR operation between the value of the pixel, 00000011, and the identification number of the second Bézier curve region 2910, 00000010, yields 00000001. The final pixel value is thus 00000001, which is the identification number of the first shape 2900. This is correct because, as indicated in FIG. 29A, the conflicting region is part of the first shape 2900.

Accordingly, after executing the bitwise XOR operation with shapes having unique identification numbers, a final result includes an array of pixels each having a value of zero, corresponding to a pixel not within any shape, or having a non-zero value corresponding to a unique identification number of a shape. Thus, each non-zero pixel may be uniquely associated with a specific shape based on the above-described method. As discussed above, an order in which the bitwise XOR operations are performed is not deterministic of a result.

Although the examples provided above describe each identification number as an 8-bit binary value, it is to be appreciated that other numbering schemes may be implemented, and pixels are not limited to 8-bit values. Furthermore, in some examples, identification numbers may not be entirely unique. For example, if each identification number is represented as an 8-bit value, up to 255 shapes may be given unique identification numbers. If there are more than 255 shapes, then certain shapes may share identification numbers. In certain examples shapes are permitted to share identification numbers, at least because errors may primarily arise only if two adjacent shapes having identical identification numbers. In various examples, in assigning identification numbers, features may be executed to maximize a distance between shapes having identical identification numbers.

Accordingly, each shape may be uniquely rendered as a series of straight lines and/or Bézier curves with a minimized chance of shape interference. As discussed above, calculating the Bézier curves for each shape may be executed in any order and may therefore be executed in parallel simply by feeding the matrix T and the control points P₁-P₄ defining each Bézier curve into a processor. In some examples, processing the Bézier curves in this manner enables a GPU to simultaneously execute many of such calculations in parallel, drastically reducing rendering times. Moreover, such processing is enabled on a client-side device without requiring plugins that are not already typically present on client-side devices or in typical client-side browsers. Accordingly, these examples are highly efficient and very convenient for users, as existing client-side devices are already capable of supporting these efficient operations.

As discussed above, such as with respect to act 214 of the process 200 and act 1918 of the process 1900, converting objects from a first format, such as a raster-graphics format, to a second format, such as a vector-graphics format, may include tracing the object in the first format and determining one or more Bézier curves representative of the traced object. In other examples, vectorization may include alternate examples, as discussed below with respect to FIG. 30.

FIG. 30 illustrates a process 3000 of converting objects from a first format to a second format according to an example. For example, the process 3000 may provide a method of converting objects from a raster-graphics, or bitmap, format to a vector-graphics format in a unit of media, which may include one or more scenes. In various examples, the process 3000 may be an example of, or provide an alternative to, act 214 of the process 200 and/or act 1918 of the process 1900.

At act 3002, the process 3000 begins.

At act 3004, contours are extracted from objects in one or more scenes. For example, the objects may be represented in a first format, such as a series of bitmaps, and act 3004 may include determining contours representative of the objects. Contours may include continuous lines outlining each object. In various examples, an outline of each object may be represented by a single contour. Certain objects may be represented by multiple contours, such as where the object includes one or more holes inside of an outline, or exterior contour, of the object. In this example, such an object may be represented by a number of contours equal to a number of holes inside the object, plus one additional contour to represent an exterior contour of the object. Determining a contour for an object may include executing a contour-finding algorithm, such as a findContours function in OpenCV.

At act 3006, key points are determined. Key points include points along a contour which may be used to represent the contour. Key points may be located at certain important points along the contour, such as points at which a contour curves at an angle greater than a threshold amount. For example, a key point may be located at each point that a contour curves greater than 30 degrees over a certain length of the contour. Act 3006 may thus include identifying, for each contour, one or more key points of the respective contour. Determining one or more key points may include executing a key-point-determination algorithm, such as a Douglas-Peucker algorithm in OpenCV. Key points may be determined for each individual frame independently of other frames, such that determining that a key point exists in one frame has no bearing on whether a key point is determined to exist in a subsequent or preceding frame.

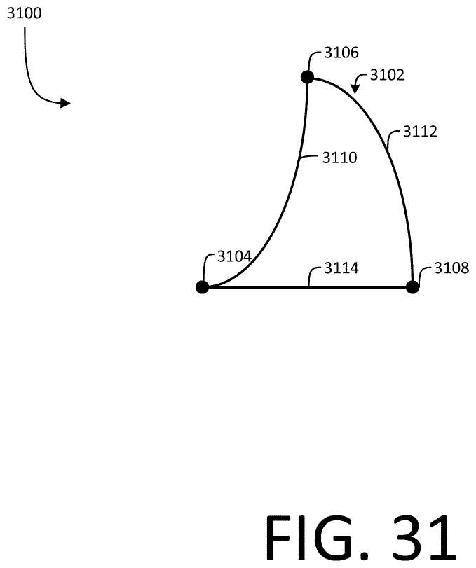

At act 3008, segments are determined. Segments are portions of a contour and include lines, which may be straight or curved, beginning at one key point and ending at another key point. For example, a segment may be a Bézier curve. Each contour may be composed of one or more contiguous segments. For example, FIG. 31 illustrates a first shape 3100 represented by a contour 3102. The contour 3102 includes a first key point 3104, a second key point 3106, and a third key point 3108. The contour 3102 is broken into a first segment 3110, a second segment 3112, and a third segment 3114. The first segment 3110 begins at the first key point 3104 and ends at the second key point 3106. The second segment 3112 begins at the second key point 3106 and ends at the third key point 3108. The third segment 3114 begins at the third key point 3108 and ends at the first key point 3104. Where a contour is known, such as the contour 3102, and key points of the contour are known, such as the key points 3104-3108, segments may be determined, at least because each segment refers to a portion of the contour between two successive key points along the contour.

At act 3010, key points are matched across multiple frames. As an object moves across successive frames, a contour representing the object may move and/or morph, causing key points associated with the contour to move. A global identifier may be associated with each unique key point. Act 3010 may include determining, for each key point, whether the key point is the same key point as from a preceding frame, although the key point may have moved and the contour to which the key point corresponds may have morphed. If a key point in a first frame is determined to be the same key point as in a second, preceding frame, each may be associated with the same unique global identifier. In this manner, each unique key point may be tracked and associated with a unique global identifier to distinguish between each unique key point.

In some examples, a contour representing an object may change across multiple successive frames in a manner that causes additional or fewer key points to be present relative to previous frames. Key points that are present in one frame but not in any preceding frame may be assigned a new unique global identifier. Otherwise, if a key point is present in a frame and is also present in one or more preceding frames, then that key point will be associated with the unique global identifier that uniquely identified the key point in the one or more preceding frames.

Key point matching may include determining one or more differences between a subject key point in a first frame and each key point in a second, successive frame to determine whether the key point corresponds to any key point in the second frame. The one or more differences may include determining a difference in Euclidean space, determining a difference in neighborhood curvature (that is, curvature of a contour around the key point), and a difference in orientation of the neighborhood curvature's angle (for example, with respect to an axis, such as the x-axis), each difference being between the subject key point and each key point in the second frame. The three differences may be individually squared and summed to determine a sum-of-squares error for the subject key point and each key point in the second frame. In some examples, certain differences may be given higher or lower weights than other differences. A key point in the second frame having a lowest sum-of-squares error with the subject key point may be determined to be the same key point. In some examples, the sum-of-squares error may be required to be below a certain threshold error. If the lowest error is still not below the threshold error, then it may be determined that the subject key point is not present in the second frame.

At act 3012, objects are matched between successive frames. As discussed above, each object is associated with one or more key points determined at act 3006. Moreover, key points may be matched across successive frames as discussed above with respect to act 3010. Act 3012 may therefore include determining, for each subject object, an object in a second, successive frame having a highest number or proportion of key points matched with the key points of the subject object. In various examples, a threshold number or proportion of matching key points may be required to determine an object match to account for situations in which a subject object is not present in the second frame.

At act 3014, key frames are determined. In some examples, it may not be necessary to store a representation of every key point and/or segment in every frame. It may instead be possible to store a representation of key points and/or segments in certain frames, referred to as “key frames,” from which other key points and/or segments may be interpolated. For example, two non-successive key frames may be used to determine one or more key points and/or segments for frames between the two key frames. Key frames may be determined separately for key points and segments.

Determining key frames for key points may include recursively adding additional, intermediate key frames until interpolations between frames fall below a certain threshold. For example, a first frame and a last frame for each scene may first be selected as key frames. Intermediate key frames between the first and last frames may be repeatedly added to the list of key frames. As each new key frame is added, a determination is made as to an interpolation between the key points of each successive key frame. The interpolation may be determined as a linear movement between key points in successive key frames. If the interpolations are too weak (that is, the key frames do not represent the full set of frames above a threshold level of accuracy), then additional key frames are added. When a determination is made that the interpolations are sufficiently strong (that is, the key frames represent the full set of frames above a threshold level of accuracy), the current set of key frames may be identified as a final set of key frames to represent the key points. Determining the interpolations may include executing an algorithm such as the Douglas-Peucker algorithm.

Determining key frames for segments may be similarly, and may include determining an interpolation between key frames and recursively adding key frames until an interpolation is sufficiently strong. The interpolation may be determined as a coordinate system transformation between the segments. In a first key frame, a coordinate system may be defined having an origin at a start point of the segment, with the x-axis of the coordinate system being defined by a line (referred to as a “source vector”) connecting the start point to the end point of the segment. In each subsequent key frame, a vector (referred to as a “destination vector”) may be defined as starting at the start point of the segment and ending at the end point of the segment. A mathematical transformation between the source vector to the destination vector may be determined to yield a coordinate system transformation. The coordinate system transformation may be multiplied by the segment in the first key frame to yield a transformed segment representing (or interpolating) the segment in the subsequent key frame having the destination vector. If the transformed segment represents the segment in the subsequent key frame having the destination frame below a threshold of accuracy, then additional key frames may be added until the transformation segment represents the segment in the subsequent key frame above the threshold of accuracy.

At act 3016, key frames are stored. For key point key frames, coordinates of key points in a first key frame may be stored. For subsequent key frames, information indicative of movement of the key points in the first key frame may be stored. That is, rather than storing the coordinates of the subsequent key points, information indicative of a movement of the key point in an x- and y-dimension relative to a preceding key frame may be stored. As discussed above, movement of the key points in frames between the key frames may subsequently be interpolated based on the stored information. For segment key frames, Bézier curve parameters indicative of the segments may be stored. For example, the Bézier curve parameters may include control points of the Bézier curves. In some examples, key frames for objects need not be explicitly stored at least because objects are capable of being reconstructed from segments. That is, by storing key frames for segments, the objects represented by a collection of segments may be inherently stored. In various examples, key frame information may be stored in a JSON file.

At act 3018, the process 3000 ends.

Accordingly, the process 3000 provides a method of vectorizing objects represented in a first format and storing information indicative of the vectorized objects. The stored information may subsequently be read to render the vectorized objects using the rendering techniques discussed above.

Various controllers, such as the controllers 110, 118, may execute various operations discussed above. Using data stored in associated memory, the controllers 110, 118 also execute one or more instructions stored on one or more non-transitory computer-readable media that may result in manipulated data. In some examples, the controllers 110, 118 may include one or more processors or other types of controllers. In one example, the controllers 110, 118 are, or include, a commercially available, general-purpose processor. In another example, the controllers 110, 118 perform at least a portion of the operations discussed above using an application-specific integrated circuit (ASIC) tailored to perform particular operations in addition to, or in lieu of, a general-purpose processor. As illustrated by these examples, examples in accordance with the present invention may perform the operations described herein using many specific combinations of hardware and software and the invention is not limited to any particular combination of hardware and software components.

Although certain processes have been illustrated with certain series of acts, no limitation is implied by an order of acts listed in the illustrated processes. Acts of the processes described above may be executed in orders other than those specifically illustrated.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method of converting media content from a first format to a vector-graphics format, the method comprising:
receiving video media content in the first format;
detecting a plurality of scenes in the video media content;
selecting at least one scene of the plurality of scenes for conversion to the vector-graphics format;
identifying a plurality of objects including a first object in the at least one scene;
determining at least one of a morphing of the first object and a transformation of the first object in the at least one scene;
converting the plurality of objects from the first format to the vector-graphics format; and
storing information indicative of the first object and the at least one of the morphing of the first object and the transformation of the first object in the vector-graphics format.

2. The method of claim 1, wherein the first format is a raster-graphics format.

3. The method of claim 2, wherein selecting the at least one scene for conversion to the vector-graphics format includes:
determining a plurality of gradient intensity values corresponding to a plurality of pixels in a frame of the at least one scene;
determining a first number of gradient intensity values falling within a first threshold range;
determining a second number of gradient intensity values falling within a second threshold range, the second threshold range being different than the first threshold range; and
determining that the at least one scene may be converted to the vector-graphics format based on a difference between the first number of gradient intensity values and the second number of gradient intensity values.

4. The method of claim 2, wherein the at least one scene includes a first frame and a second frame, the second frame being subsequent to the first frame, the first frame including a first plurality of pixels representing the first object and the second frame including a second plurality of pixels representing the first object, and wherein identifying the first object includes:
assigning a first pixel of the first plurality of pixels to a first region;
adding at least one first border pixel of the first plurality of pixels to the first region responsive to determining that the at least one first border pixel has a color value within a threshold range of a color value of the first region, the at least one first border pixel being adjacent to the first region; and
adding at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

5. The method of claim 2, wherein converting the first object to the vector-graphics format includes:
determining a contour of the first object;
determining a plurality of key points along the contour; and
determining one or more segments between key points of the plurality of key points, the one or more segments being represented in a vector-graphics format.

6. The method of claim 2, further comprising:
identifying the first object as a foreground object; and
identifying a second object as a background object.

7. The method of claim 6, wherein identifying the second object as the background object includes:
identifying a plurality of images each including a respective portion of the background object;
combining the plurality of images to generate a static image of the background object; and
storing the static image of the background object.

8. A non-transitory computer-readable medium storing thereon sequences of computer-executable instructions for converting media content from a first format to a vector-graphics format, the sequences of computer-executable instructions including instructions that instruct at least one processor to:
receive video media content in the first format;
detect a plurality of scenes in the video media content;
select at least one scene of the plurality of scenes for conversion to the vector-graphics format;
identify a plurality of objects including a first object in the at least one scene;
determine at least one of a morphing of the first object and a transformation of the first object in the at least one scene;
convert the plurality of objects from the first format to the vector-graphics format; and
store information indicative of the first object and the at least one of the morphing of the first object and the transformation of the first object in the vector-graphics format.

9. The non-transitory computer-readable medium of claim 8, wherein the first format is a raster-graphics format.

10. The non-transitory computer-readable medium of claim 9, wherein in instructing the at least one processor to select the at least one scene for conversion to the vector-graphics format, the instructions are further configured to instruct the at least one processor to:
determine a plurality of gradient intensity values corresponding to a plurality of pixels in a frame of the at least one scene;
determine a first number of gradient intensity values falling within a first threshold range;
determine a second number of gradient intensity values falling within a second threshold range, the second threshold range being different than the first threshold range; and
determine that the at least one scene may be converted to the vector-graphics format based on a difference between the first number of gradient intensity values and the second number of gradient intensity values.

11. The non-transitory computer-readable medium of claim 9, wherein the at least one scene includes a first frame and a second frame, the second frame being subsequent to the first frame, the first frame including a first plurality of pixels representing the first object and the second frame including a second plurality of pixels representing the first object, and wherein in instructing the at least one processor to identify the first object, the instructions are further configured to instruct the at least one processor to:
assign a first pixel of the first plurality of pixels to a first region;
add at least one first border pixel of the first plurality of pixels to the first region responsive to determining that the at least one first border pixel has a color value within a threshold range of a color value of the first region, the at least one first border pixel being adjacent to the first region; and
add at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

12. The non-transitory computer-readable medium of claim 9, wherein in instructing the at least one processor to convert the first object to the vector-graphics format, the instructions are further configured to instruct the at least one processor to:
determine a contour of the first object;
determine a plurality of key points along the contour; and
determine one or more segments between key points of the plurality of key points, the one or more segments being represented in a vector-graphics format.

13. The non-transitory computer-readable medium of claim 9, wherein the instructions are further configured to instruct the at least one processor to:
identify the first object as a foreground object; and
identify a second object as a background object.

14. The non-transitory computer-readable medium of claim 13, wherein in instructing the at least one processor to identify the second object as the background object, the instructions are further configured to instruct the at least one processor to:
identify a plurality of images each including a respective portion of the background object;
combine the plurality of images to generate a static image of the background object; and
store the static image of the background object.

15. A computing device configured to convert media content from a first format to a vector-graphics format, the computing device comprising:
a communication interface;
a storage; and
a controller configured to:
receive, via the communication interface, video media content in the first format;
detect a plurality of scenes in the video media content;
select at least one scene of the plurality of scenes for conversion to the vector-graphics format;
identify a plurality of objects including a first object in the at least one scene;
determine at least one of a morphing of the first object and a transformation of the first object in the at least one scene;
convert the plurality of objects from the first format to the vector-graphics format; and
store information indicative of the first object and the at least one of the morphing of the first object and the transformation of the first object in the vector-graphics format in the storage.

16. The computing device of claim 15, wherein the first format is a raster-graphics format.

17. The computing device of claim 16, wherein in selecting the at least one scene for conversion to the vector-graphics format, the controller is further configured to:
determine a plurality of gradient intensity values corresponding to a plurality of pixels in a frame of the at least one scene;
determine a first number of gradient intensity values falling within a first threshold range;
determine a second number of gradient intensity values falling within a second threshold range, the second threshold range being different than the first threshold range; and
determine that the at least one scene may be converted to the vector-graphics format based on a difference between the first number of gradient intensity values and the second number of gradient intensity values.

18. The computing device of claim 16, wherein the at least one scene includes a first frame and a second frame, the second frame being subsequent to the first frame, the first frame including a first plurality of pixels representing the first object and the second frame including a second plurality of pixels representing the first object, the controller is further configured to:
assign a first pixel of the first plurality of pixels to a first region;
add at least one first border pixel of the first plurality of pixels to the first region responsive to determining that the at least one first border pixel has a color value within a threshold range of a color value of the first region, the at least one first border pixel being adjacent to the first region; and
add at least one second border pixel of the second plurality of pixels to the first region responsive to determining that the at least one second border pixel has a color value within a threshold range of a color value of the first region, the at least one second border pixel being adjacent to the first region where the first plurality of pixels forms a first layer of a three-dimensional matrix and the second plurality of pixels forms a second layer of the three-dimensional matrix, the first layer being adjacent to the second layer.

19. The computing device of claim 16, wherein in converting the first object to the vector-graphics format, the controller is further configured to:
determine a contour of the first object;
determine a plurality of key points along the contour; and
determine one or more segments between key points of the plurality of key points, the one or more segments being represented in a vector-graphics format.

20. The computing device of claim 16, wherein the controller is further configured to:
identify the first object as a foreground object;
identify a second object as a background object;
identify a plurality of images each including a respective portion of the background object;
combine the plurality of images to generate a static image of the background object; and
store the static image of the background object in the storage.
